(19) United States
(12) Patent Application Publication
(10) Pub. No.: US 2023/0192572 A1
(43) Pub. Date: Jun. 22, 2023

(54) COMPOSITIONS FOR ENHANCING NITROGEN STABILIZERS AND METHODS AND USES THEREOF

(71) Applicant: Verdesian Life Sciences U.S., LLC, Cary, NC (US)

(72) Inventors: Gary Orr, Pittsboro, NC (US); Ashish Arun PANDYA, Morrisville, NC (US); Kuide QIN, Chapel Hill, NC (US)

(21) Appl. No.: 17/911,757

(22) PCT Filed: Mar. 16, 2021
(86) PCT No.: PCT/US2021/022523

§ 371 Date: Sep. 15, 2022

Related U.S. Application Data
(60) Provisional application No. 62/991,880, filed on Mar. 19, 2020.

(51) Int. Cl. C05G 3/90; C08F 222/06

(52) U.S. Cl. CPC C05G 3/90; C08F 222/06; C08F 2810/00

(57) ABSTRACT

The presently disclosed subject matter is directed to nitrogen-stabilizing compositions containing nitrogen stabilizers condensed with organic acid anhydrides. The resulting condensation products exhibit numerous beneficial properties such as increased thermal stability and the ability to provide a controlled and continuous release of nitrogen stabilizer, thereby promoting increased nutrient availability to plants and crops.

### FIELD OF THE INVENTION

The presently disclosed subject matter is directed to compositions containing nitrogen stabilizers and organic acid anhydrides, including the synthesis thereof. Further described are uses of the compositions in agriculture to increase nutrient uptake and inhibit nitrification and/or urease activity.

### BACKGROUND

Nitrogen is an essential plant nutrient thought to be important for adequate and strong foliage. Urea provides a large nitrogen content and is the dominant nitrogen fertilizer. In the presence of soil moisture, natural or synthetic ureas are converted to ammonium ion, which is then available for plant uptake. Ammonium can be further converted by bacteria in soil to nitrate through a nitrification process. Nitrate is also available for plant uptake. However, the urea usage efficiency by plants is low.

In practice, nitrogen fertilizer is often just applied once at the beginning of the growing season. Typically nitrogen fertilizer is formulated as dry granules, prills, or as fluids made up of urea alone or mixed with ammonium nitrate as UAN (a mixture containing urea, ammonium nitrate, and water). Urea is also present in animal manure. These forms of urea have a significant disadvantage in that they undergo rapid decomposition and generate ammonia gas when applied to soil. This is due to the presence of urease enzyme in soils, which reacts with urea to produce ammonium bicarbonate and ammonia. This general set of processes is known in the art as volatilization. Volatilization results in decreased efficiency of nitrogen fertilizer use, lower yields, plant symptoms of nitrogen deficiency, undesirable odors, and potentially harmful ammonia gas concentrations. In addition, the generated ammonia can also be converted to nitrate by bacteria in the soil, which is called nitrification. Excessive nitrate can be converted into nitric oxide or nitrous oxide by certain types of bacteria in the soil, which is called denitrification.

Nitrification and/or urease inhibitors (often referred to as nitrogen stabilizers) have been developed that are capable of delaying degradation of nitrogen fertilizer, thereby reducing losses of nitrogenous degradation products that would otherwise occur in the absence of these inhibitors. The use of nitrification and/or urease inhibitors in combination with nitrogen fertilizers tends to increase the amount of time the nitrogen source remains in the soil and available for absorption by the plants, which then increases the effectiveness of the fertilizer, positively impacting crop yield and quality. However, problems relating to cost, safety, convenience, and stability have limited the use of these types of inhibitors. For example, current products contain expensive organic solvents and have low composition percentages of the inhibitors in the liquid formulations. This necessitates a larger percentage application of these liquid dispersed systems, thus making their use uneconomical and inefficient. Such products include, for example, Neon Series™ from Eco Agro Resources, where NBPT and DCD are formulated at low concentrations in organic solvents.

Therefore, finding economical delivery formulations that are safe for the environment and animals and contain the proper balance and concentration of nitrification and urease inhibitor(s) that may be applied directly to liquid fertilizer (such as UAN) would be highly desirable. Thus, despite the continuous ongoing research efforts to improve upon existing products, there still remains a significant need in the art for developing better methods and compositions that contain nitrogen stabilizers for efficiently controlling enzyme-induced urea decomposition.

### SUMMARY OF THE INVENTION

In one aspect, the subject matter described herein is directed to a nitrogen-stabilizing composition comprising a nitrogen stabilizer component and an organic acid anhydride component. In some embodiments, the nitrogen-stabilizing composition further comprises nitrapyrin.

In one aspect, the subject matter described herein is directed to a formulation or an agricultural composition containing the disclosed nitrogen-stabilizing composition. In some embodiments, the agricultural composition contains a fertilizer.

In one aspect, the subject matter described herein is directed to a method of inhibiting soil-borne urease enzyme comprising the step of applying to the soil a nitrogen-stabilizing composition or a formulation as disclosed herein, wherein the nitrogen-stabilizing composition or formulation is present in a quantity sufficient to inhibit the decomposition of urea by the action of soil-borne urease enzyme.

In one aspect, the subject matter described herein is directed to a method of preparing a nitrogen-stabilizing composition as disclosed herein comprising contacting a nitrogen stabilizer component with an acid anhydride component thereby forming condensation product(s).

### DETAILED DESCRIPTION

The presently disclosed subject matter will now be described more fully hereinafter.

However, many modifications and other embodiments of the presently disclosed subject matter set forth herein will come to mind to one skilled in the art to which the presently disclosed subject matter pertains, having the benefit of the teachings presented in the foregoing descriptions. Therefore, it is to be understood that the presently disclosed subject matter is not to be limited to the specific embodiments disclosed and that modifications and other embodiments are intended to be included within the scope of the appended claims. In other words, the subject matter described herein covers all alternatives, modifications, and equivalents. In the event that one or more of the incorporated literature, patents, and similar materials differs from or contradicts this application, including but not limited to defined terms, term usage, described techniques, or the like, this application controls. Unless otherwise defined, all technical and scientific terms used herein have the same meaning as commonly understood by one of ordinary skill in this field. All publications, patent applications, patents, and other references mentioned herein are incorporated by reference in their entirety.

As mentioned above, urea is one of the major nitrogen fertilizers that is widely used in agriculture production. It is believed that up to 40% of the nitrogen applied as urea can be lost if applied incorrectly, because after it is applied in the field it can react with water through the urease enzyme to form ammonium carbonate. Ammonium carbonate is unstable and breaks down into carbon dioxide and ammonia, which can be volatized and lost to the air. The losses can be substantial and are dependent on a number of factors such as soil pH, soil temperature, soil moisture, cation exchange capacity of the soil, and soil organic matter content.

Many methods for controlling volatile nitrogen losses from urea have been developed or proposed, including the application of metal salts of copper and zinc, boron compounds, organic urease inhibitors, acid coatings, polymer coatings, and reaction of urea with aldehydes to form reaction adducts. For example, N-(butyl) thiophosphoric acid triamide (NBPT) is one of the most known urease inhibitors in agriculture worldwide. However, the compound itself is thermally unstable and decomposes when in contact with water and acid. Once decomposed, it is not effective in providing the desired inhibitory effects on the urease enzyme. Thus, formulations that reduce the loss and decomposition rate of NBPT, which in turn can improve its efficacy in the soil, would be of great value in reducing the negative environmental impact of the compound itself.

Advantageously, the compositions and methods described herein have been shown to provide desirable properties for the use of nitrogen stabilizers, such as NBPT and/or dicyandiamide (DCD), in agriculture by formulating these nitrogen stabilizers with organic acid anhydrides. Combining these nitrogen stabilizers with organic acid anhydrides has provided nitrogen-stabilizing compositions exhibiting beneficial properties such as, but not limited to, extended thermal stability, extended chemical stability, extended enzymatic stability, increased shelf life, reduced volatility, reduced application rate, ease of handling, extended/prolonged effect of urease and nitrification inhibition, as well as excellent environmental and toxicology profiles. As such, the compositions disclosed herein not only contribute to an increased availability of the nitrogen stabilizer, but also to extending longevity in their performance as an efficient nitrogen stabilizer.

### Definitions

As used herein, the term “condensation” or “condensation reaction” refers to a reaction in which two or more molecules combine to form a larger molecule (i.e., condensation product) with the simultaneous loss of a small molecule such as water (H₂O).

As used herein, the term “reactive” refers to describing the measure of how readily a substance is able to undergo a chemical reaction thereby changing its molecular structure. For instance, how readily a substance is able to undergo a condensation reaction with another molecule to form condensation product(s). Reactivity of a substance can be modulated with temperature, pressure, and/or solvents.

As used herein, the term “aromatic ring system” refers to ring systems that contain at least one heteroaryl ring and/or at least on aryl ring, wherein the ring contains at least five atoms or more.

As used herein, the term “heteroaryl” refers to a radical that comprises at least a five-membered or six-membered unsaturated and conjugated aromatic ring containing at least two ring carbon atoms and one to four ring heteroatoms selected from nitrogen, oxygen, and/or sulfur. Such heteroaryl radicals are often alternatively termed “heteroaromatic” by those of skill in the art. In some instances, the heteroaryl radicals have from two to twelve carbon atoms, or alternatively four to five carbon atoms in the heteroaryl ring. Examples include, but are not limited to, pyridinyl, pyrimidinyl, pyrazinyl, pyrrolyl, furanyl, tetrazolyl, isoxazolyl, oxadiazolyl, benzothiophenyl, benzofuranyl, quinolinyl, isoquinolinyl and the like.

As used herein, the term “aryl” refers to a radical comprising at least one unsaturated and conjugated six-membered ring analogous to the six-membered ring of benzene. Aryl radicals having such unsaturated and conjugated rings are also known to those of skill in the art as “aromatic” radicals. Preferred aryl radicals have 6 to 12 ring carbons. Aryl radicals include, but are not limited to, aromatic radicals comprising phenyl and naphthyl ring radicals.

As used herein, the term “substituted” refers to a moiety (such as heteroaryl, aryl, alkyl, and/or alkenyl), wherein the moiety is bonded to one or more additional organic or inorganic substituent radicals. In some embodiments, the substituted moiety comprises 1, 2, 3, 4, or 5 additional substituent groups or radicals. Suitable organic and inorganic substituent radicals include, but are not limited to, hydroxyl, cycloalkyl, aryl, substituted aryl, heteroaryl, heterocyclic ring, substituted heterocyclic ring, amino, mono-substituted amino, di-substituted amino, acyloxy, nitro, cyano, carboxy, carboalkoxy, alkyl carboxamide, substituted alkyl carboxamide, dialkyl carboxamide, substituted dialkyl carboxamide, alkyl sulfonyl, alkylsulfinyl, thioalkyl, alkoxy, substituted alkoxy or haloalkoxy radicals, wherein the terms are defined herein. Unless otherwise indicated herein, the organic substituents can comprise from 1 to 4 or from 5 to 8 carbon atoms. When a substituted moiety is bonded thereon with more than one substituent radical, then the substituent radicals may be the same or different.

As used herein, the term “unsubstituted” refers to a moiety (such as heteroaryl, aryl, alkenyl, and/or alkyl) that is not bonded to one or more additional organic or inorganic substituent radicals as described above, meaning that such a moiety is only substituted with hydrogens.

As used herein, the term “halo,” “halogen,” or “halide” refers to a fluoro, chloro, bromo, or iodo atom or ion.

As used herein, the term “alkoxy” refers to an alkyl radical bound through a single, terminal ether linkage; that is, an “alkoxy” group can be defined as —OR where R is alkyl as defined above. Examples include, but are not limited to, methoxy, ethoxy, n-propoxy, iso-propoxy, n-butoxy, t-butoxy, iso-butoxy and the like.

As used herein, the term “substituted alkoxy” refers to an alkoxy radical as defined above having one, two, or more additional organic or inorganic substituent radicals bound to the alkyl radical. Suitable organic and inorganic substituent radicals include, but are not limited to, hydroxyl, cycloalkyl, amino, mono-substituted amino, di-substituted amino, acyloxy, nitro, cyano, carboxy, carboalkoxy, alkyl carboxamide, substituted alkyl carboxamide, dialkyl carboxamide, substituted dialkyl carboxamide, alkylsulfonyl, alkylsulfinyl, thioalkyl, thiohaloalkyl, alkoxy, substituted alkoxy, or haloalkoxy. When the alkyl of the alkoxy is bonded thereon with more than one substituent radical, then the substituent radicals may be the same or different.

As used herein, the term “amino” refers to a substituted or unsubstituted trivalent nitrogen-containing radical or group that is structurally related to ammonia (NH3) by the substitution of one or more of the hydrogen atoms of ammonia by a substituent radical.

As used herein, the term “mono-substituted amino” refers to an amino substituted with one radical selected from alkyl, substituted alkyl, or arylalkyl, wherein the terms have the same definitions found herein.

As used herein, the term “di-substituted amino” refers to an amino substituted with two radicals that may be the same or different selected from aryl, substituted aryl, alkyl, substituted alkyl or arylalkyl, wherein the terms have the same definitions as disclosed herein. Examples include, but are not limited to, dimethylamino, methylethylamino, diethylamino and the like. The two substituent radicals present may be the same or different.

As used herein, the term “haloalkyl” refers to an alkyl radical, as defined above, substituted with one or more halogens, such as fluorine, chlorine, bromine, or iodine, preferably fluorine. Examples include, but are not limited to, trifluoromethyl, pentafluoroethyl and the like.

As used herein, the term “haloalkoxy” refers to a haloalkyl, as defined above, that is directly bonded to oxygen to form trifluoromethoxy, pentafluoroethoxy and the like.

As used herein, the term “acyl” denotes a radical containing a carbonyl (—C(O)—R) group wherein the R group is hydrogen or has 1 to 8 carbons. Examples include, but are not limited to, formyl, acetyl, propionyl, butanoyl, iso-butanoyl, pentanoyl, hexanoyl, heptanoyl, benzoyl and the like.

As used herein, the term “acyloxy” refers to a radical containing a carboxyl (—O—C(O)—R) group wherein the R group comprises hydrogen or 1 to 8 carbons. Examples include, but are not limited to, acetyloxy, propionyloxy, butanoyloxy, iso-butanoyloxy, benzoyloxy and the like.

As used herein, the term “alkyl group” refers to a saturated hydrocarbon radical containing 1 to 8, 1 to 6, 1 to 4, or 5 to 8 carbons. In some instances, the alkyl group refers to a saturated hydrocarbon radical containing more than 8 carbons. An alkyl group is structurally similar to a noncyclic alkane compound modified by the removal of one hydrogen from the noncyclic alkane, and the substitution therefor of a non-hydrogen group or radical. Alkyl group radicals can be branched or unbranched. Lower alkyl group radicals have 1 to 4 carbon atoms. Higher alkyl group radicals have 5 to 8 carbon atoms. Examples of alkyl, lower alkyl, and higher alkyl group radicals include, but are not limited to, methyl, ethyl, n-propyl, isopropyl, n-butyl, sec-butyl, t-butyl, amyl, t-amyl, n-pentyl, n-hexyl, i-octyl and like radicals.

As used herein, the term “alkenyl group” refers to an unsaturated hydrocarbon radical containing 2 to 8, 2 to 6, 2 to 4, or 5 to 8 carbons and at least one carbon-carbon double bond. In some instances, the alkenyl group refers to an unsaturated hydrocarbon radical that contains more than 8 carbons. The unsaturated hydrocarbon radical is similar to an alkyl radical, as defined above, that also comprises at least one carbon-carbon double bond. Examples include, but are not limited to, vinyl, allyl, 2-butenyl, 3-butenyl, 2-pentenyl, 3-pentenyl, 4-pentenyl, 2-hexenyl, 3-hexenyl, 4-hexenyl, 5-hexanyl, 2-heptenyl, 3-heptenyl, 4-heptenyl, 5-heptenyl, 6-heptenyl and the like. The term “alkenyl” includes dienes and trienes of straight and branch chains.

As used herein, the term “monocyclic” refers to a molecular structure that contains a single ring of atoms such as, for example, benzene or cyclopropane.

As used herein, the term “bicyclic” refers to a molecular structure that contains two rings of atoms that are fused together such as, for example, naphthalene.

As used herein, the term “tricyclic” refers to a molecular structure that contains three rings of atoms that are fused together.

As used herein, the term “covalent bond” refers to a chemical bond that involves the sharing of electron pairs between atoms. These electron pairs are known as shared pairs or bonding pairs, and the stable balance of attractive and repulsive forces between atoms, when they share electrons, is known as covalent bonding.

As used herein, “nitrogen stabilizers” refers to any substance or mixture of substances intended for preventing or hindering the process of nitrification, denitrification, ammonia volatilization, or urease production through action upon soil bacteria.

As used herein, “nitrification inhibitor” refers to a property of a compound to inhibit oxidation of ammonia to nitrite/nitrate.

As used herein, the term “urease inhibitor” refers to a property of a compound to inhibit the activity of urease enzymes. The inhibition can be quantified as described elsewhere herein.

As used herein, the term “thermal stability” refers to the stability of a substance when exposed to a thermal stimuli over a given period of time. Examples of thermal stimuli include, but are not limited to, heat generated from an electrical source and/or heat generated from the sun.

As used herein, the term “chemical stability” refers to the resistance of a substance to structurally change when exposed to an external action such as air (which can lead to oxidation), light (e.g., sun light), moisture/humidity (from water), heat (from the sun), and/or chemical agents. Exemplary chemical agents include, but are not limited to, any organic or inorganic substance that can degrade the structural integrity of the compound of interest (e.g., the disclosed polyanionic polymer).

As used herein, the term “enzymatic stability” refers to the resistance of a substance to external biological organisms to break down the structural stability of a substance (e.g., disclosed anionic polymer). Exemplary biological organisms include, but are not limited to, bacteria and microorganisms present in the soil.

As used herein, the term “effective amount” refers to an amount of a nitrogen-stabilizing composition and/or the amount of each component in the stabilizing composition (i.e., nitrogen stabilizer component and/or organic acid anhydride component), which is sufficient for achieving nitrification inhibition and/or urease inhibition as described below. More exemplary information about amounts, ways of application, and suitable ratios to be used is given below. A skilled artisan is well aware of the fact that such an amount can vary in a broad range, and is dependent on various factors, e.g., weather, target species, locus, mode of application, soil type, treated cultivated plant or material, and the climatic conditions.

As used herein, the term “soil” is to be understood as a natural body comprised of living (e.g., microorganisms (such as bacteria and fungi), animals, and plants) and nonliving matter (e.g., minerals and organic matter (e.g., organic compounds in varying degrees of decomposition), liquid, and gases) that occurs on the land surface, and is characterized by soil horizons that are distinguishable from the initial material as a result of various physical, chemical, biological, and anthropogenic processes. From an agricultural point of view, soils are predominantly regarded as the anchor and primary nutrient base for plants (plant habitat).

As used herein, the term “fertilizer” is to be understood as chemical compounds applied to promote plant and fruit growth. Fertilizers are typically applied either through the soil (for uptake by plant roots) or by foliar feeding (for uptake through leaves). The term “fertilizer” can be subdivided into two major categories: a) organic fertilizers (composed of decayed plant/animal matter) and b) inorganic fertilizers (composed of chemicals and minerals). Organic fertilizers include manure, slurry, worm castings, peat, seaweed, sewage, and guano. Green manure crops are also regularly grown to add nutrients (especially nitrogen) to the soil. Manufactured organic fertilizers include compost, blood meal, bone meal, and seaweed extracts. Further examples are enzymatically digested proteins, fish meal, and feather meal. The decomposing crop residue from prior years is another source of fertility. In addition, naturally occurring minerals such as mine rock phosphate, sulfate of potash, and limestone are also considered inorganic fertilizers. Inorganic fertilizers are usually manufactured through chemical processes (such as the Haber-Bosch process), also using naturally occurring deposits, while chemically altering them (e.g., concentrated triple superphosphate). Naturally occurring inorganic fertilizers include Chilean sodium nitrate, mine rock phosphate, and limestone.

As used herein, the term “manure” is organic matter used as organic fertilizer in agriculture. Depending on its structure, manure can be divided into liquid manure, semi-liquid manure, stable or solid manure, and straw manure. Depending on its origin, manure can be divided into manure derived from animals or plants. Common forms of animal manure include feces, urine, farm slurry (liquid manure), or farmyard manure (FYM), whereas FYM also contains a certain amount of plant material (typically straw), which may have been used as bedding for animals. Animals from which manure can be used comprise horses, cattle, pigs, sheep, chickens, turkeys, rabbits, and guano from seabirds and bats. The application rates of animal manure when used as fertilizer highly depends on the origin (type of animals). Plant manures may derive from any kind of plant, whereas the plant may also be grown explicitly for the purpose of plowing them in (e.g., leguminous plants), thus improving the structure and fertility of the soil. Furthermore, plant matter used as manure may include the contents of the rumens of slaughtered ruminants, spent hops (left over from brewing beer), or seaweed.

As used herein, the term “seed” comprises seeds of all types, such as, for example, corns, seeds, fruits, tubers, seedlings, and similar forms. The seed used can be the seed of the useful plants mentioned above, but also the seed of transgenic plants or plants obtained by customary breeding methods.

Throughout this specification and the claims, the words “comprise,” “comprises,” and “comprising” are used in a nonexclusive sense, except where the context requires otherwise, and are synonymous with “including,” “containing,” or “characterized by,” meaning that it is open-ended and does not exclude additional, unrecited elements or method steps.

As used herein, the transitional phrase “consisting essentially of” limits the scope of a claim to the specified materials or steps “and those that do not materially affect the basic and novel characteristic(s)” of the claimed presently disclosed subject matter.

As used herein, the transitional phrase “consisting of” excludes any element, step, or ingredient not specified in the claim.

As used herein, the term “about” when referring to a value is meant to encompass variations of in some embodiments ±5%, in some embodiments ±2%, in some embodiments ±1%, in some embodiments ±0.5%, and in some embodiments ±0.1% from the specified amount, as such variations are appropriate to perform the disclosed methods or employ the disclosed compositions.

Where a range of values is provided, it is understood that each intervening value, to the tenth of the unit of the lower limit, unless the context clearly dictates otherwise, between the upper and lower limit of the range and any other stated or intervening value in that stated range, is encompassed. The upper and lower limits of these small ranges which may independently be included in the smaller ranges are also encompassed, subject to any specifically excluded limit in the stated range. Where the stated range includes one or both of the limits, ranges excluding either or both of those included limits are also included.

Additional definitions may follow below.

### I. Composition

The presently disclosed subject matter relates to nitrogen-stabilizing compositions comprising a nitrogen stabilizer component and an organic acid anhydride component. In some embodiments, the nitrogen stabilizer component comprises a nitrification inhibitor, a urease inhibitor, or a combination thereof. In some embodiments, the nitrogen stabilizer component contains a nitrogen-containing moiety such as a primary and/or secondary amine functionality. In some embodiments, the organic acid anhydride component is a linear and/or cyclic organic acid monomer, a linear and/or cyclic organic acid polymer, or a combination thereof.

The relative amount of each component (i.e., the nitrogen stabilizer component and the organic acid anhydride component) present in the nitrogen-stabilizing composition can vary. For example, in some embodiments, the nitrogen stabilizer component and the organic acid anhydride component are present in the nitrogen-stabilizing composition in amounts ranging from about 1:1,000 to about 1,000:1; from about 1:100 to about 100:1, from about 1:50 to about 50:1, from about 1:25 to about 25:1, from about 1:10 to about 10:1, from about 1:5 to about 5:1, or from about 1:2 to 2:1, or about 1:1 molar ratio of nitrogen stabilizer component to organic acid anhydride component.

In some embodiments, the amount of nitrogen stabilizer component present in the nitrogen-stabilizing composition ranges from about 1% to about 99%, from about 1% to about 90%, from about 1% to about 80%, from about 1% to about 70%, or from about 1% to about 60%, from about 1% to about 50%, from about 1% to about 40%, from about 1% to about 30% from about 1% to about 20%, or from about 1% to about 10% by weight (or no more than about 50%, about 45%, about 40%, about 35%, about 30%, about 25%, about 20%, about 15, or no more than about 10% by weight) based on the total weight of the nitrogen stabilizer composition.

In some embodiments, the amount of organic acid anhydride component present in the nitrogen-stabilizing composition ranges from about 1% to about 99%, from about 1% to about 90%, from about 1% to about 80%, from about 1% to about 70%, or from about 1% to about 60%, from about 1% to about 50%, from about 1% to about 40%, from about 1% to about 30% from about 1% to about 20%, or from about 1% to about 10% by weight (or no more than about 50%, about 45%, about 40%, about 35%, about 30%, about 25%, about 20%, about 15, or no more than about 10% by weight) based on the total weight of the nitrogen stabilizer composition.

In some embodiments, the nitrogen stabilizer component reacts with the organic acid anhydride component to form condensation products. In such embodiments, the condensation products comprise mono-alkylated condensation products, di-alkylated condensation products, or a combination thereof.

In some embodiments, the nitrogen-stabilizing composition comprises condensation products, a nitrogen stabilizer component, an organic acid anhydride component, or a combination thereof. In some embodiments, only a portion of the nitrogen stabilizer component condenses with the organic acid anhydride component while the remaining portion remains “free” (i.e., not condensed). In some embodiments, only a portion of the organic acid anhydride component condenses with the nitrogen stabilizer component while the remaining portion of the organic acid anhydride component remains “free” (i.e., not condensed). The amount of condensed nitrogen stabilizer component in the nitrogen-stabilizing composition can vary. In some embodiments, the amount of condensed nitrogen stabilizer component present in the nitrogen-stabilizing composition ranges from about 1% to about 99%, from about 10% to about 95%, from about 20% to about 90%, from about 30% to about 80%, or from about 40% to about 70% based on the weight of the nitrogen stabilizer component.

The amount of condensed organic acid anhydride component in the nitrogen-stabilizing composition can vary. In some embodiments, the amount of condensed organic acid anhydride component present in the nitrogen-stabilizing composition ranges from about 1% to about 99%, from about 10% to about 95%, from about 20% to about 90%, from about 30% to about 80%, or from about 40% to about 70% based on the weight of the organic acid anhydride component.

In some embodiments, the entire amount of nitrogen stabilizer component reacts (i.e., condenses) with the organic acid anhydride component to form condensation products. For example, in such embodiments, the organic acid anhydride component is available in an amount such that one molecule of nitrogen stabilizer component is able to react with one molecule of the organic acid anhydride component to form a mono-alkylated condensation product. In some embodiments, the organic acid anhydride component is available in an amount such that one molecule of the nitrogen stabilizer component is able to react with two molecules of the organic acid anhydride component to form a di-alkylated condensation product.

Not to be bound by theory, but it is believed that when the nitrogen stabilizer and organic acid anhydride form condensation products, such products exhibit improved thermal, chemical, and/or enzymatic stability, thereby reducing the decomposition of the nitrogen stabilizer. Presumably, when the condensation product is generated, an imide group (R—C(═O)—N(R)—C(═O)—R; where R can be any alkyl group and/or aryl group) is formed upon reaction of the nitrogen stabilizer with the organic acid anhydride. This imide group not only is believed to provide the observed increased thermal, chemical and/or enzymatic stability but is also believed to modulate the hydrolysis rate of the condensation product and thereby the subsequent release of the nitrogen stabilizer into the soil environment. The ability to modulate the rate of hydrolysis of the condensation products allows for a constant and continuous supply of nitrogen stabilizer. As a result, this constant amount/concentration of nitrogen stabilizer to plants provides improved nutrient supply to surrounding plants.

In some embodiments, the nitrogen-stabilizing composition further comprises a second nitrification inhibitor and/or a urease inhibitor. In such an embodiment, the additional nitrification inhibitor and/or urease inhibitor does not react with the organic acid anhydride component and can be the same as or different than the nitrification inhibitor(s) and/or urease inhibitor(s) present in the nitrogen stabilizer component.

The nitrogen stabilizer component and organic acid anhydride component are discussed in more detail below.

### A.1. Nitrogen Stabilizer Component

The nitrogen stabilizer component disclosed herein can comprise a urease inhibitor and/or a nitrification inhibitor. In some embodiments, the urease inhibitor and/or nitrification inhibitor disclosed herein are inhibitors exhibiting sufficient reactivity towards an organic acid anhydride component to chemically react with such organic acid anhydride component to form covalent bonds between atoms and/or moieties of the urease and/or nitrification inhibitor and the organic acid anhydride component. A skilled artisan would be aware of the urease inhibitors and/or nitrification inhibitors that are suitable to react with such an organic acid anhydride component. For example, in some embodiments, the urease inhibitor and/or nitrification inhibitor comprises at least one or more amine functional group(s), such as primary, secondary, and/or tertiary amines, which are sufficiently reactive to form covalent bonds with the organic acid anhydride component thereby producing condensation products.

In some embodiments, the nitrogen stabilizer component is a urease inhibitor. Exemplary urease inhibitors include, but are not limited to, thiophosphoric-based urease inhibitors such as, but not limited to, N-alkyl-thiophosphoric triamides (e.g., N-(n-butyl) thiophosphoric triamide (NBPT) and N-(n-propyl) thiophosphoric triamide), N-cycloalkyl-thiophosphoric triamides, N-aryl-thiophosphoric triamides (e.g., N-(2-nitrophenyl) phosphoric acid triamide), and any derivative thereof. In some embodiments, the urease inhibitor is NBPT. In some embodiments, the nitrogen stabilizer component is a combination of urease inhibitors. In some embodiments, the one or more urease inhibitors are selected from thiourea-based urease inhibitors, urea-based urease inhibitors, phosphor(di)amide-based urease inhibitors, substituted semicarbazones (e.g., (2E)-2-[(3-fluorophenyl)methylidene] hydrazine-1-carboxamide and (2E)-2-[(4-nitrophenyl)methylidene]hydrazine-1-carboxamide), polyphenols (e.g., methyl gallate, baicalin, scutellarin, 1,2,3,4,6-penta-O-galloyl-D-glucoside, caffeic acid, and tannic acid), hydroxy-aldehydes (like salicylaldehyde and vanillin), amino aromatics (like methoxy aniline) and a combination thereof.

In some embodiments, the nitrogen stabilizer component is a nitrification inhibitor. Exemplary nitrification inhibitors include, but are not limited to, dicyandiamide (DCD) and any derivative thereof. In some embodiments, the nitrification inhibitor is DCD. In some embodiments, the nitrogen stabilizer component is a combination of nitrification inhibitors. In some embodiments, the one or more nitrification inhibitors are selected from pyrazoles (e.g., 3,4-dimethylpyrazole and 4-chloro-3-methylpyrazole), propargylamine, substituted alkynes (e.g., 2-methyl-3-butyn-2-ol, 3,5-dimethyl-1-hexyn-3-ol) substituted thioureas (e.g., N-allylthiourea and 1-amidino-2-thiourea), and a combination thereof.

In some embodiments, the nitrogen stabilizer component is a urease inhibitor and a nitrification inhibitor. For example, in some embodiments, the urease inhibitor is NBPT and the nitrification inhibitor is DCD. The relative amounts of the urease inhibitor and the nitrification inhibitor present in the nitrogen stabilizer component can vary. For example, in some embodiments, the amount of the urease inhibitor ranges from about 1 to about 99% by weight and the amount of the nitrification inhibitor ranges from about 99 to about 1% by weight based on the total weight of the nitrogen stabilizer component. In some embodiments, the amount of the urease inhibitor ranges from about 10% to about 90%, from about 20% to about 80%, from about 30% to about 70%, or 40% to about 60% by weight and the amount of the nitrification inhibitor ranges from about 90% to about 10%, from about 80% to about 20%, from about 70% to about 30%, from about 60% to about 40% by weight, respectively, based on the total weight of the nitrogen-stabilizing composition. In some embodiments, the amount of urease inhibitor is less than about 90%, less than about 80%, less than about 70%, less than about 60%, less than about 50%, less than about 40%, less than about 30%, less than about 20%, or less than about 10% by weight based on the total weight of the nitrogen-stabilizing composition. In some embodiments, the amount of nitrification inhibitor is less than about 90%, less than about 80%, less than about 70%, less than about 60%, less than about 50%, less than about 40%, less than about 30%, less than about 20%, or less than about 10% by weight based on the total weight of the nitrogen-stabilizing composition. In some embodiments, the urease inhibitor and nitrification inhibitor are present in the nitrogen-stabilizing composition in amounts ranging from about 1:100 to about 100:1; from about 1:75 to about 75:1, from about 1:50 to about 50:1, from about 1:25 to about 25:1, from about 1:10 to about 10:1, from about 1:5 to about 5:1, or from about 1:2 to 2:1, or about 1:1 molar ratio of urease inhibitor to nitrification inhibitor.

### A.2. Organic Acid Anhydride Component

The disclosed organic acid anhydride component is selected from a linear organic acid anhydride monomer, a cyclic organic acid anhydride monomer, a linear organic acid anhydride polymer, a cyclic organic acid anhydride polymer, and combinations thereof; wherein each one of them is described in more detail below.

### A.2.1. Linear and Cyclic Organic Acid Anhydride Monomers

The linear organic acid anhydride monomer disclosed herein can be any linear organic acid anhydride monomer that is reactive to form a condensation product with a nitrogen stabilizer as disclosed herein. In some embodiments, the linear organic acid anhydride monomer has the formula as shown below:

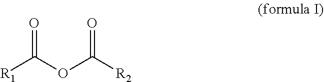

wherein R₁ and R₂ are independently selected from a substituted or unsubstituted C₁-C₈ alkyl group, a substituted or unsubstituted C₂-C₈ alkenyl group, a substituted or unsubstituted C₃-C₈ cycloalkyl group, a substituted or unsubstituted aryl group, and a substituted or unsubstituted heteroaryl group.

In some embodiments, the linear organic acid anhydride monomer is saturated. In some embodiments, the linear organic acid anhydride is unsaturated. In some embodiments, the linear organic acid anhydride monomer contains 1, 2, 3, 4, 5, or 6 double bonds.

In some embodiments, the organic acid anhydride monomer is a cyclic organic acid anhydride monomer. The cyclic organic acid anhydride monomer disclosed herein can be any cyclic organic acid anhydride monomer that is sufficiently reactive to form a condensation product with a nitrogen stabilizer component as disclosed herein. In some embodiments, the cyclic organic acid anhydride component is monocyclic. In some embodiments, the cyclic organic acid anhydride is bi- or tricyclic.

In some embodiments, the cyclic organic acid anhydride monomer is monocyclic as shown in formula II below:

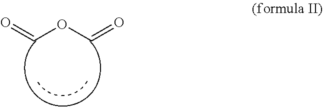

wherein [symbol] indicates any bonds in the above acid anhydride-containing ring structure of formula II that can be unsaturated (e.g., represents a double bond).

In some embodiments, the cyclic organic acid anhydride monomer is saturated. In some embodiments, the cyclic organic acid anhydride is unsaturated. In some embodiments, the cyclic organic acid anhydride monomer contains one double bond. In some embodiments, the cyclic organic acid anhydride monomer contains more than one double bond (e.g., 2, 3, 4 or 5 double bonds). Exemplary cyclic organic acid anhydride containing one or more double bonds include, but are not limited to, glutaconic anhydride, 3,6-dihydro-2,7-oxepindione, 2,7-oxepindione, 4,7-dihydro-2H-oxocin-2,8(3H)-dione, and/or 3,4,7,8-tetrahydro-2,9-oxonidione.

The ring size of the cyclic organic acid anhydride monomer can vary. For example, in some embodiments, the cyclic organic acid anhydride monomer is selected from a five-membered, six-membered, seven-membered, eight-membered, nine-membered, ten-membered, eleven-membered, or twelve-membered cyclic organic acid anhydride monomer or a combination thereof. Exemplary cyclic organic acid anhydride monomers include, but are not limited to, glutaric anhydride, adipic anhydride, 2,8-oxocanedione, 2,9-oxonanedione, 2,10-oxecanedione, sebacic anhydride, and/or oxacyclododecane-2,12-dione.

In some embodiments, the cyclic organic acid anhydride monomer is a five-membered cyclic organic acid anhydride monomer. In some embodiments, the cyclic organic acid anhydride monomer is maleic anhydride. In some embodiments, the cyclic organic acid anhydride monomer is succinic anhydride.

In some embodiments, the cyclic organic acid anhydride monomer is substituted with one or more substituents. In some embodiments, the organic acid anhydride is bi- or tricyclic. Exemplary bi- or tricyclic organic acid anhydride monomers include, but are not limited to, hexahydrophthalic anhydride, methyl hexahydrophthalic anhydride, methyl tetrahydrophthalic anhydride, tetrahydrophthalic anhydride, himic anhydride, chlorendic anhydride, phthalic anhydride, trimellitic anhydride, tetrachlorophthalic anhydride, pyromellitic dianhydride, tetrabromophthalic anhydride, succinic anhydride, citraconic anhydride, maleic anhydride, or combinations thereof.

### A.2.2. Organic Acid Anhydride Polymers

The organic acid anhydride component comprises an organic acid anhydride polymer, wherein the anhydride moiety is sufficiently reactive to form condensation products with the nitrogen stabilizer component as disclosed herein. In some embodiments, the organic acid anhydride polymer is a copolymer of two different repeat units. In some embodiments, the organic acid anhydride polymer is a copolymer of more than two different repeat units. In some embodiments, at least one of the two different repeat units contains an anhydride moiety. In some embodiments, the organic acid anhydride polymer can be, but is not limited to, a random copolymer, an alternating copolymer, a periodic copolymer, a statistical copolymer, or a block copolymer. In some embodiments, the organic acid anhydride polymer is a random copolymer. In some embodiments, the organic acid anhydride polymer is a terpolymer or a tetrapolymer.

In some embodiments, the organic acid anhydride polymer has a high content of anhydride moieties, which makes them very soluble in water and biodegradable. In some embodiments, the organic acid anhydride polymer has a content of anhydride moieties of at least 75%, 80%, 85%, 90%, 95% or 98 mole %. In some embodiments, the organic acid anhydride polymer has a content of anhydride moieties ranging from about 50% to about 99%, from about 60% to about 98%, from about 70% to about 95%, or from about 80% to about 90 mole%.

The repeat units are derived from corresponding monomers used in the synthesis of the organic acid anhydride polymers. In some embodiments, the organic acid anhydride polymer contains type B and type C repeat units. These repeat units and their corresponding monomers are discussed in more detail below.

### A.3.1. Type B Repeat Units

Type B repeat units can be selected from repeat units derived from substituted or unsubstituted monomers of linear and/or cyclic organic acid anhydrides, as discussed above, containing a double bond. In some embodiments, the linear organic acid anhydrides can be derived from monomers of linear organic acid anhydrides according to formula III shown below:

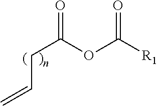

wherein R₁ is selected from a substituted or unsubstituted C₁-C8 alkyl group, a substituted or unsubstituted C₂-C₈ alkenyl group, a substituted or unsubstituted C₃-C₈ cycloalkyl group, a substituted or unsubstituted aryl group, and a substituted or unsubstituted heteroaryl group; and

n is an integer selected from 0, 1, 2, 3, 4, 5, 6, 7, 8, 9, or 10.

In some embodiments, the cyclic organic acid anhydrides can be derived from monomers of cyclic organic acid anhydrides according to formula IV shown below:

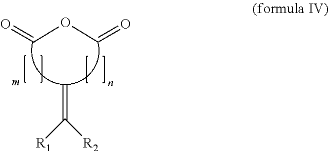

wherein R₁ and R₂ are independently selected from —H, —OH, —COOH, —COOR, —OCOH, OCOR, —OR, —CN, —SO₂R, —SO₃R, —COR, —CONH₂, —CONHR, —CONR₂, —CHO, NO₂, halogen —alkyl, -cycloalkyl, -aryl, -alkaryl, or aralkyl, wherein R is a substituted or unsubstituted C₁-C₈ alkyl group;

n on the above ring portion shows the number of carbon atoms as an integer selected from 1, 2, 3, 4, 5, 6, 7, 8, 9, or 10; and

m on the above ring portion shows the number of carbons as an integer selected from 1, 2, 3, 4, 5, 6, 7, 8, 9, or 10.

The ring size of the cyclic organic acid anhydride moiety in the above formula IV can vary. For example, in some embodiments, the cyclic organic acid anhydride moiety is selected from a five-membered, six-membered, seven-membered, eight-membered, nine-membered, ten-membered, eleven-membered, or twelve-membered cyclic organic acid anhydride monomer, or a combination thereof. In some embodiments, the cyclic organic acid anhydride monomer is a five-membered cyclic organic acid anhydride moiety.

In some embodiments, the type B repeat unit is derived from maleic anhydride. In some embodiments, the type B repeat unit is derived from itaconic anhydride.

### A.3.2. Type C Repeat Units

Type C repeat units can be selected from repeat units derived from substituted or unsubstituted monomers of alkenes according to formula V:

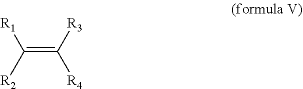

wherein R₁, R₂, R₃, and R₄ are independently selected from —H, —COOH, —COOR, —OCOH, —OCOR, —OR, —CN, —SO₂R, —SO₃R, —COR, —CONH₂, —CONHR, —CONR₂, —CHO, NO₂, halogen -alkyl, -cycloalkyl, -aryl, -alkaryl, or aralkyl, wherein R is a substituted or unsubstituted C₁-C₈ alkyl group.

Examples of classes of monomers that may be used are alkenes such as ethylene, propylene, butene-1 (butylene), iso-butylene, pentene-1, hexene-1, heptene-1, octene-1, 2,4,4-trimethyl pentene-1, trimethyl ethylene, trans-stilbene and methylene cyclohexane; cycloalkenes such as cyclopentene and cyclohexene; aralkenes such as styrene, trimethyl styrene, a-ethyl styrene and other substituted derivatives of styrene; vinyl ethers such as methyl vinyl ether, ethyl vinyl ether, propyl vinyl ether, isopropyl vinyl ether and isobutyl vinyl ether; isopropenyl ethers such as methyl isopropenyl ether; ethylenically unsaturated carboxylic acids, their esters and nitriles such as methyl acrylate, ethyl acrylate, 2-ethyl hexyl acrylate, acrylonitrile, methyl methacrylate and methacrylonitrile; ethylenically unsaturated dicarboxylic acids, their mono- and diesters, nitriles, anhydrides, and imides such as dimethyl maleate, diethyl maleate, dibutyl maleate, maleic anhydride, maleimide, N-methyl maleimide, N-ethyl maleimide, N-phenyl maleimide, N-p-chlorophenyl maleimide, dimethyl fumarate, diethyl fumarate, dibutyl fumarate, itaconic anhydride, monobutyl itaconate, citraconic anhydride, mesaconic anhydride and vinylidene cyanide; and halogen-substituted alkenes such as vinyl chloride, vinylidene chloride, allyl chloride and methallyl chloride.

In some embodiments, the type C repeat unit is derived from ethylene, propylene, butylene, isobutylene, styrene, methyl vinyl ether or a combination thereof.

Broadly speaking, the organic acid anhydride polymers disclosed herein include recurring polymeric subunits made up of two different moieties individually and respectively taken from the group consisting of what have been denominated for ease of reference as B and C moieties;

alternately, the cyclic organic acid anhydride polymers may be formed from recurring B moieties. Thus, exemplary polymeric subunits may be BC, CB, BB, or any other combination of B and C moieties; moreover, in a given cyclic organic acid anhydride polymer, different polymeric subunits may include different types of moieties, e.g., in an BC recurring polymeric unit polymer, the B moiety may be different in different units.

In detail, moiety B is of the general formula VI:

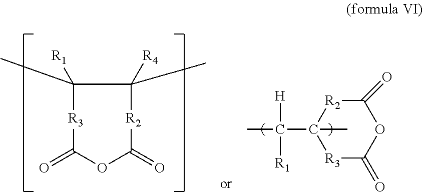

wherein R₁ and R₄ are independently selected from —H, —OH, —COOH, —COOR, —OCOH, —OCOR, —OR, —CN, —SO₂R, —SO₃R, —COR, —CONH₂, —CONHR, —CONR₂, —CHO, NO₂, halogen -alkyl, -cycloalkyl, -aryl, -alkaryl, or aralkyl, wherein R is a substituted or unsubstituted C₁-C₈ alkyl group, a substituted or unsubstituted C₂-C₈ alkenyl group, a substituted or unsubstituted aryl group, a substituted or unsubstituted heteroaryl group; and

R₂ and R₃ are independently selected from a bond or substituted or unsubstituted C₁-C₈ alkyl group.

Moiety C is of the general formula VII:

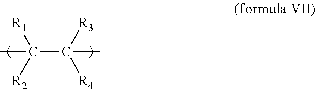

which can be further divided into the following three sub-formulae:

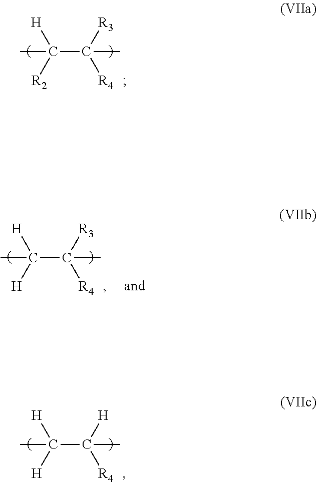

wherein R₁R₂, R₃ and R₄ are independently selected from —H, —COOH, —COOR, —OCOH, —OCOR, —OR, —CN, —SO₂R, —SO₃R, —COR, —CONH₂, —CONHR, —CONR₂, —CHO, NO₂, halogen -alkyl, -cycloalkyl, -aryl, -alkaryl, or aralkyl, wherein R is a substituted or unsubstituted C₁-C₈ alkyl group, a substituted or unsubstituted C₂-C₈ alkenyl group, a substituted or unsubstituted aryl group, a substituted or unsubstituted heteroaryl group.

As can be appreciated, the disclosed organic acid anhydride polymers can have different sequences of recurring polymeric subunits as defined above (for example, a polymer comprising B and C subunits may include all two forms of B subunit and all four forms of C subunit). However, for reasons of cost and ease of synthesis, the most useful polymers include recurring polymeric subunits made up of B and C moieties.

The most preferred organic acid anhydride polymers are composed of recurring polymeric subunits formed of B and C moieties and have the generalized formula VIII:

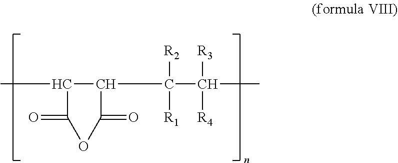

wherein R₁ R₂, R₃ and R₄ are independently selected from —H, —COOH, —COOR, —OCOH, —OCOR, —OR, —CN, —SO₂R, —SO₃R, —COR, —CONH₂, —CONHR, —CONR₂, —CHO, NO₂, halogen -alkyl, -cycloalkyl, -aryl, -alkaryl, or aralkyl, wherein R is a substituted or unsubstituted C₁-C₈ alkyl group, a substituted or unsubstituted C₂-C₈ alkenyl group, a substituted or unsubstituted aryl group, a substituted or unsubstituted heteroaryl group; and

n is an integer greater than 2.

Other preferred forms of this polymer are capable of having a wide range of repeat unit concentrations in the polymer. For example, polymers having varying ratios of B:C (e.g., 10:90, 60:40, 50:50 and even 0:100) are contemplated and embraced by the presently disclosed subject matter. Such polymers would be produced by varying monomer amounts in the reaction mixture from which the final product is eventually produced, and the type B and C repeating units may be arranged in the polymer backbone in random order or in an alternating pattern.

In some embodiments, at least about 80 mole %, about 85%, about 90%, or about 95% of the repeat units therein are type B repeat units. In some embodiments, these repeat units are randomly located along the polymer.

The polymers of the presently disclosed subject matter may have a wide variety of molecular weights, ranging, for example, from about 500 to about 5,000,000 Da, from about 1,000 to about 500,000 Da or from about 10,000 to about 50,000 Da depending chiefly upon the desired end use. Additionally, n can range from about 1 to about 10,000 and more preferably from about 1 to about 5,000.

In general, the above polymers can be made by free radical polymerization, thus converting selected monomers into polymers with repeat units. Such polymers may be further modified to impart particular structures and/or properties. A variety of techniques can be used for generating free radicals, such as addition of peroxides, hydroperoxides, azo initiators, persulfates, percarbonates, per-acid, charge transfer complexes, irradiation (e.g., UV, electron beam, X-ray, gamma radiation and other ionizing radiation types), and combinations of these techniques. An extensive variety of methods and techniques are well known in the art of polymer chemistry for initiating free radical polymerizations.

The polymerization reactions are carried out in a compatible solvent system, namely a system which does not unduly interfere with the desired polymerization, using desired monomer concentrations. A number of suitable aqueous or nonaqueous solvent systems can be employed, such as ketones, alcohols, esters, ethers, aromatic solvents, water and mixtures thereof. Water alone and the lower (C₁-C₄) ketones and alcohols are especially preferred, and these may be mixed with water if desired. In some instances, the polymerization reactions are carried out with the substantial exclusion of oxygen, and most usually under an inert gas such as nitrogen or argon. There is no particular criticality in the type of equipment used in the synthesis of the polymers, i.e., stirred tank reactors, continuous stirred tank reactors, plug flow reactors, tube reactors and any combination of the foregoing arranged in series may be employed. A wide range of suitable reaction arrangements are well known to the art of polymerization.

In general, the initial polymerization step is carried out at a temperature of from about 0° C. to about 120° C. (more preferably from about 30° C. to about 95° C. for a period of from about 0.25 hours to about 24 hours and even more preferably from about 0.25 hours to about 5 hours). Usually, the reaction is carried out with continuous stirring and upon completion of the polymerization reaction the polymer can be isolated.

### II. Preparative Methods

As mentioned above, the disclosed nitrogen-stabilizing compositions can contain condensation products. Methods for preparing such nitrogen-stabilizing compositions generally comprise reaction of a nitrogen stabilizer component with an organic acid anhydride component thereby generating condensation products. The condensation products can be mono-alkylated condensation products, di-alkylated condensation products (which are either uniform or mixed), or a combination thereof. When the condensation products are formed, water is released while an imide group (R—C(═O)—N(R)—C(═O)—R) is formed containing atoms from both the nitrogen stabilizer component and the organic acid anhydride component. An exemplary general reaction scheme of the formation of a mono-alkylated condensation product is shown in Scheme 1.

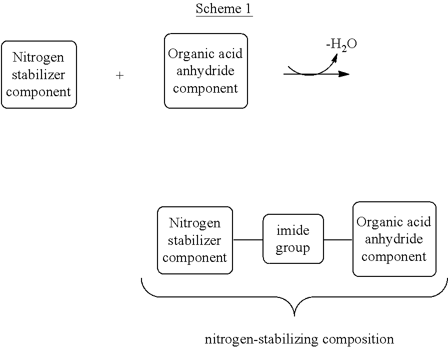

In some embodiments, the method of preparing a nitrogen-stabilizing composition comprises contacting a nitrogen stabilizer component with an organic acid anhydride component, thereby forming condensation products. The term “contacting” in this context refers to the nitrogen stabilizer being exposed to, touched with, and/or physically mixed with the organic acid anhydride component. Contacting of the two components typically occurs when both components are present in the same space (e.g., a reaction vessel and/or container) without being physically separated.

In some embodiments, one molecule of a nitrogen-stabilizing composition is contacted with one molecule of a linear organic acid anhydride component to form a mono-alkylated condensation product with a general structure according to formula IX:

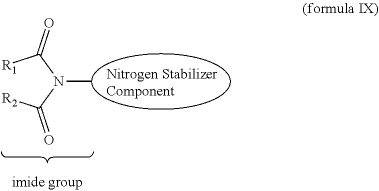

wherein R₁ and R₂ are independently selected from a substituted or unsubstituted C₁-C₈ alkyl group, a substituted or unsubstituted C2-C8 alkenyl group, a substituted or unsubstituted C₃-C₈ cycloalkyl group, a substituted or unsubstituted aryl group, and a substituted or unsubstituted heteroaryl group. In some embodiments, R₁ and R₂ are the same substituent. In some embodiments, R₁ and R₂ are different substituents.

The open imide group in formula IX is formed when the nitrogen-containing moiety of the nitrogen stabilizer component (such as an amine group; nitrogen stabilizer-NH₂) reacts with the linear organic acid anhydride (R₁—C(═O)OC(═O)—R₂) component, forming an amide intermediate (nitrogen stabilizer-NHC(═O)R₁ and/or R₂) and an organic acid (OHC(═O) R₁ and/or R₂), which subsequently reacts with the amide intermediate to render the final condensation product according to formula IX, as is shown in Scheme 2 below.

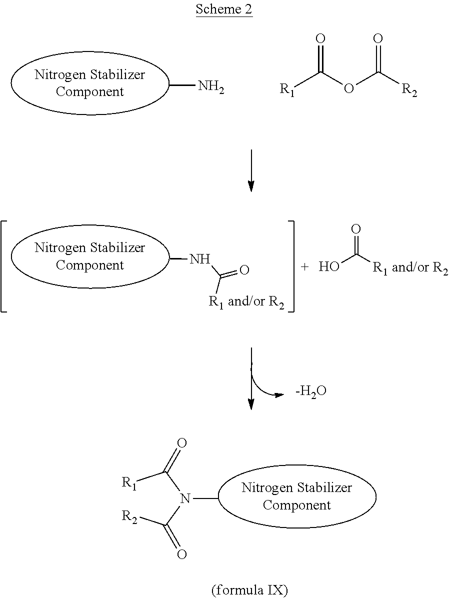

In some embodiments, one molecule of a nitrogen stabilizer component is contacted with one molecule of a cyclic organic acid anhydride component to form a mono-alkylated condensation product with a general structure according to formula X:

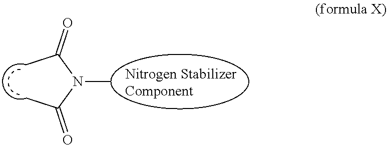

wherein the cyclic imide group in formula X is formed when a nitrogen-containing moiety of the nitrogen stabilizer component (such as an amine group; nitrogen stabilizer-NH₂) reacts with the cyclic organic acid anhydride component, and wherein [symbol] indicates any bonds in the above cyclic imide group that can be saturated or unsaturated (e.g., represents a double bond) according to the general reaction scheme shown below:

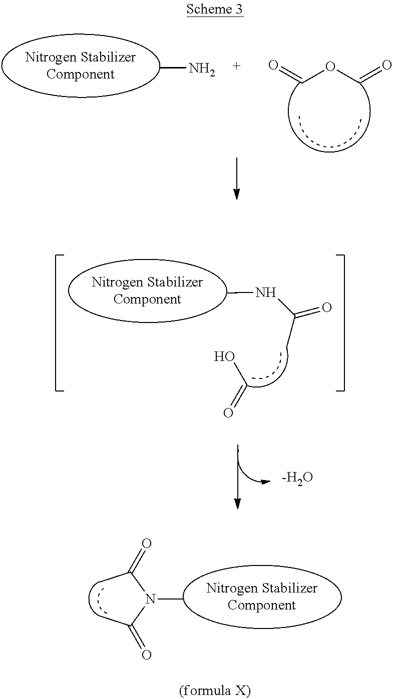

For the formation of di-alkylated condensation products, one molecule of a nitrogen stabilizer component is contacted with two molecules of an organic acid anhydride component (e.g., a first molecule and a second molecule of an organic acid anhydride). In some embodiments, the two molecules of the organic acid anhydride component are the same type of organic acid anhydride (i.e., are structurally the same). In some embodiments, the two molecules of the organic acid anhydride are of different types of organic acid anhydride (i.e., are structurally different).

In some embodiments, one molecule of a nitrogen stabilizer component is contacted with two molecules of a cyclic organic acid anhydride component (e.g., a first molecule and a second molecule of a cyclic organic acid anhydride) to form a di-alkylated condensation product, which can be uniform or mixed. In some embodiments, the two molecules of the cyclic organic acid anhydride component are the same type of cyclic organic acid anhydride and render a uniform di-alkylated condensation product containing two imide groups that are structurally the same (e.g., both imide groups are type A). Such uniform di-alkylated condensation products have a general structure according to formula XI:

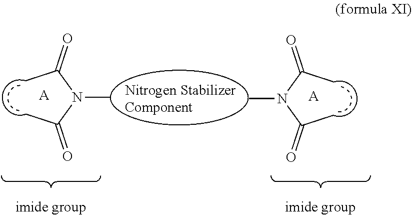

wherein the two cyclic imide groups in formula XI are formed essentially in the same manner as shown in Scheme 3 when two nitrogen-containing moieties of the nitrogen stabilizer component react with two cyclic organic acid anhydride components that are of the same type (e.g., type A), and wherein [symbol] indicates any bonds in the above cyclic imide groups that can be saturated or unsaturated (e.g., represents a double bond).

In some embodiments, the two molecules of the cyclic organic acid anhydride component are different types of cyclic organic acid anhydrides and render a mixed di-alkylated condensation product, which contains two imide groups that are structurally different (e.g., one of type A and one of type B). Such mixed di-alkylated condensation products have a general structure according to formula XII:

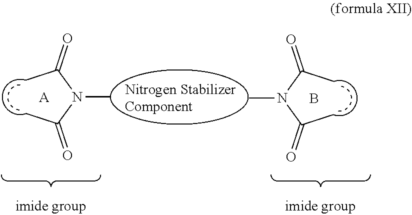

wherein the two cyclic imide groups in formula XII are formed when two nitrogen-containing moieties of the nitrogen stabilizer component react with two different types of cyclic organic acid anhydride components (e.g., type A and B), and wherein [symbol] indicates any bonds in the above cyclic imide groups that can be saturated or unsaturated (e.g., represents a double bond).

Mechanistically, di-alkylated condensation products are formed in a step-wise fashion. Not to be bound by theory, but it is believed that the first step involves reaction between one molecule of a nitrogen stabilizer component with the first molecule of a cyclic organic acid anhydride component to form a mono-alkylated condensation product (in essentially the same manner as shown in Scheme 3), which can then subsequently react with the second molecule of a cyclic organic acid anhydride component. If the second molecule of the organic acid anhydride component is structurally the same as the first molecule of cyclic organic acid anhydride component, then a uniform di-alkylated condensation product is formed. If the second molecule of the cyclic organic acid anhydride component is structurally different then the first molecule of cyclic organic acid anhydride component, then a mixed di-alkylated condensation product is formed as is shown in Scheme 4 below.

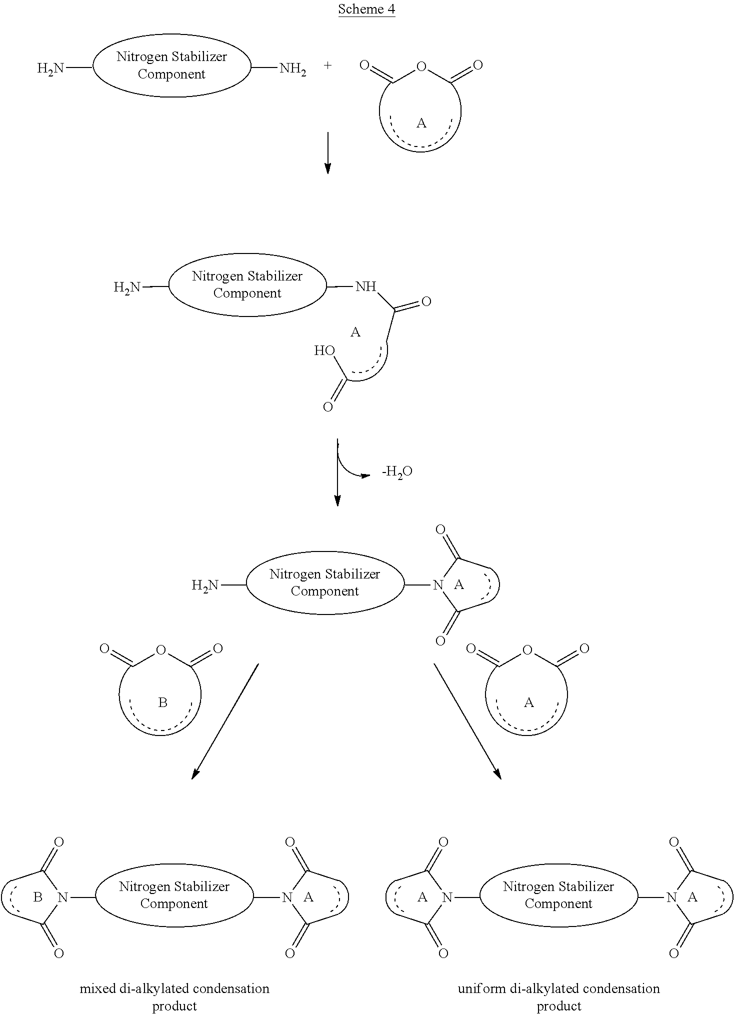

Exemplary preparation methods of mono- and di-alkylated condensation products are shown in the reaction schemes below.

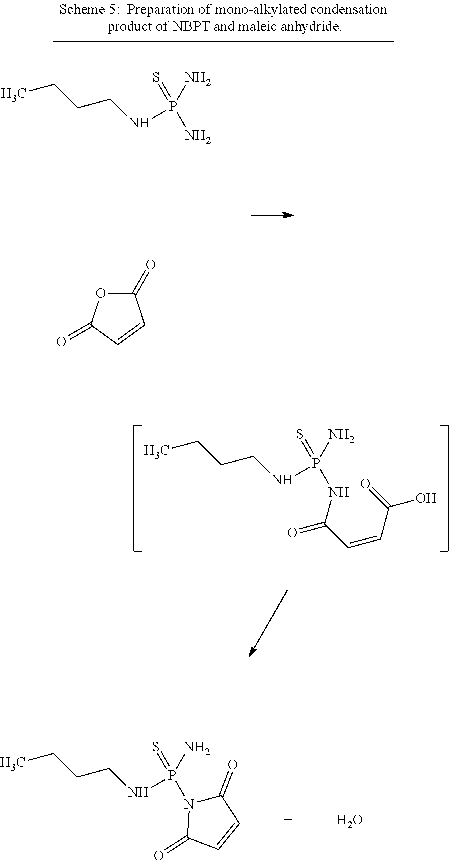

Scheme 5 shows the reaction of one molecule of nitrogen stabilizer NBPT with one molecule of maleic anhydride to render a mono-alkylated condensation product. This mono-alkylated condensation product can then optionally be exposed to a second molecule of maleic anhydride to render a uniform di-alkylated condensation product as shown in the scheme below.

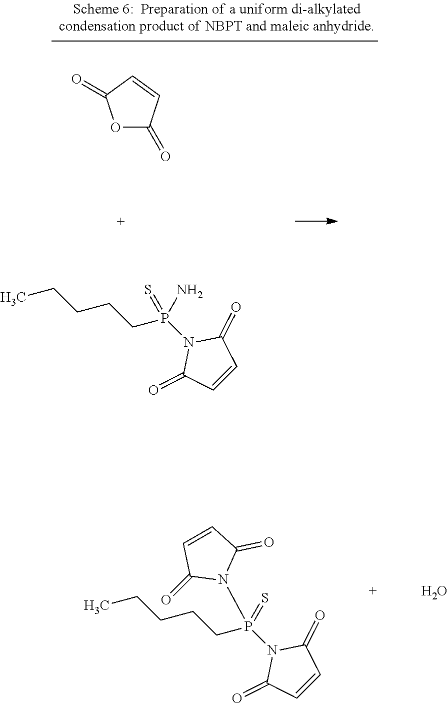 [SMILES: O=C1C=CC(=O)O1 ; CCCCCP(N)(=S)N1C(=O)C=CC1=O ; CCCCCP(=S)(N1C(=O)C=CC1=O)N1C(=O)C=CC1=O ; O]

In another example, one molecule of a nitrogen stabilizer DCD reacts with one molecule of maleic anhydride to afford a mono-alkylated condensation product as shown in Scheme 7 below.

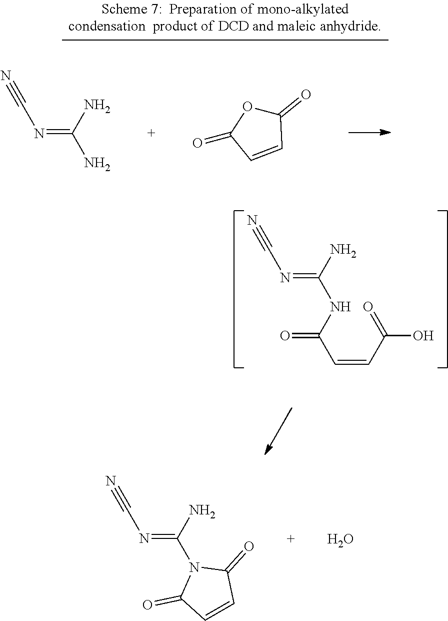

A second maleic anhydride molecule can react with the mono-alkylated condensation product to render a uniform di-alkylated condensation product as shown below.

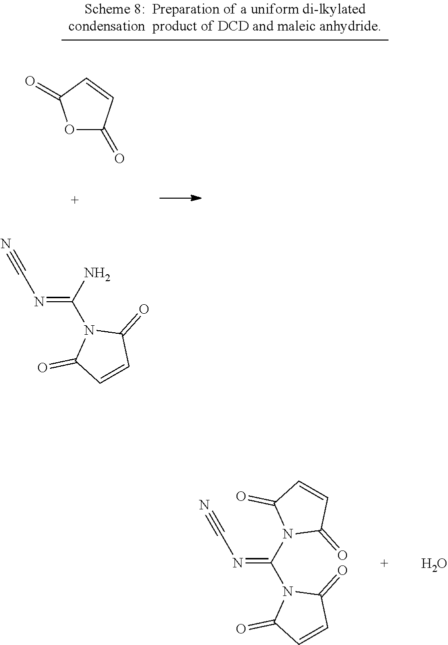 [SMILES: O=C1C=CC(=O)O1 ; N#C/N=C(\N)N1C(=O)C=CC1=O ; N#CN=C(N1C(=O)C=CC1=O)N1C(=O)C=CC1=O ; O]

Although the above examples show condensation reactions of cyclic organic acid anhydride monomers, similar condensation reactions can be carried out for cyclic organic acid anhydride polymers (e.g., maleic anhydride-containing copolymers).

In some embodiments, the above condensation reaction can be carried out solvent free. In some embodiments, the above condensation reactions can be carried out in a solvent. Exemplary solvents include, but are not limited to, alcohols (e.g., methanol, ethanol, isopropanol), ethers (e.g., diethyl ether, tetrahydrofuran), halogenated solvents (e.g., dichloromethane), esters (e.g., ethyl acetate), aromatics (e.g., benzene toluene), non-polar solvents (e.g., acetonitrile, dimethylsulfoxide) and the like.

In some embodiments, the above condensation reaction can be carried out at room temperature (e.g., about 25° C.). In some embodiments, the above condensation reaction can be carried out at elevated temperatures (e.g., at least about 30, 35, 40, 45, 50, 55, 60, 65, 70, 75, 80, 85, 90 95 or at least about 100° C.). In some embodiments, the above condensation reaction can be carried out at a temperature ranging from about 30° C. to about 100° C., from about 40° C. to about 80° C., from about 45° C. to about 75° C., or from about 50° C. to about 70° C. In some embodiments, the above condensation reaction can be carried at temperatures below room temperature (e.g., below about 20, 10, 5, 0, −5, −10, −15, −20 or below about −30° C.). In some embodiments, the above condensation reaction can be carried out at temperatures ranging from about −30° C. to about 10° C., from about −25° C. to about 5° C., from about −15° C. to about 0° C., or from about −10° C. to about −5° C.

Once the condensation products are formed, they can be removed from the solvent if present and purified using known purification methods in the art if needed (e.g., HPLC purification, distillation, chromatographic purification methods, and the like).

### III. Nitrogen-Stabilizing Composition

The nitrogen stabilizer component and the organic acid anhydride component present in the nitrogen-stabilizing composition can react to form mono-alkylated and/or di-alkylated condensation products. In some embodiments, the di-alkylated condensation product can be uniform (meaning that the imide groups of the di-alkylated condensation products are the same) or can be mixed (meaning the imide groups of the di-alkylated condensation products are different).

In some embodiments, the nitrogen-stabilizing composition further comprises a second nitrification inhibitor and/or urease inhibitor. The amount of the second nitrification inhibitor and/or urease inhibitor can vary. In some embodiments, the amount of the second nitrification inhibitor and/or urease inhibitor ranges from about 1% to about 99%, from about 5% to about 90%, from about 10% to about 80%, from about 10% to about 70%, from about 20% to about 60% or from about 30% to about 50% by weight, based on the total weight of the entire nitrogen-stabilizing composition. In some embodiments, the second nitrification inhibitor and/or urease inhibitor is the same as the nitrification inhibitor and/or urease inhibitor present in the nitrogen stabilizer component. In some embodiments, the second nitrification inhibitor and/or urease inhibitor is different compared to the nitrification inhibitor and/or urease inhibitor present in the nitrogen stabilizer component. In some embodiments, the second nitrification inhibitor is nitrapyrin.

In some embodiments, the nitrogen-stabilizing composition comprises a nitrogen stabilizer component and a second nitrification/urease inhibitor, wherein the nitrogen stabilizer component and a second nitrification/urease inhibitor are present in amounts ranging from about 1:100 to about 100:1, about 1:75 to about 75:1, about 1:50 to about 50:1, about 1:25 to about 25:1, about 1:20 to about 20:1, about 1:15 to about 15:1, about 1:10 to about 10:1, about 1:5 to about 5:1, about 1:3 to about 3:1, about 2:1 to about 2:1, or about 1:1 by weight ratio of nitrogen stabilizer component to nitrapyrin, based on the total weight of the nitrogen-stabilizing composition.

In some embodiments, the nitrogen-stabilizing composition disclosed herein is chemically, thermally, and/or enzymatically more stable compared to compositions containing a nitrogen stabilizer component that is not condensed with an organic acid anhydride component. In some embodiments, the nitrogen-stabilizing composition is at least 10%, 20%, 30%, 40%, 50%, 60%, 70%, 80%, 90%, or at least 95% more chemically stable compared to a composition containing a nitrogen stabilizer component that is not condensed with an organic acid anhydride component. In some embodiments, the nitrogen-stabilizing composition is at least 10%, 20%, 30%, 40%, 50%, 60%, 70%, 80%, 90%, or at least 95% more thermally stable compared to a composition containing a nitrogen stabilizer composition that is not condensed with an organic acid anhydride component. In some embodiments, the nitrogen-stabilizing composition is at least 10%, 20%, 30%, 40%, 50%, 60%, 70%, 80%, 90%, or at least 95% more enzymatically stable compared to a composition containing a nitrogen stabilizer composition that is not condensed with an organic acid anhydride component. The thermal/chemical/enzymatic stability of the disclosed compositions is measured as a function of the amount of nitrogen stabilizer component being present after a certain amount of time when exposed to chemical and/or thermal and/or enzymatic stimuli.

In some embodiments, the nitrogen-stabilizing composition disclosed herein is less volatile compared to compositions containing a nitrogen stabilizer component that is not condensed with a cyclic organic acid anhydride component. In some embodiments, the nitrogen-stabilizing composition is at least 10%, 20%, 30%, 40%, 50%, 60%, 70%, 80%, 90%, or at least 95% less volatile compared to a composition containing a nitrogen stabilizer composition that is not condensed with a cyclic organic acid anhydride component.

In some embodiments, the nitrogen-stabilizing composition disclosed herein inhibits the decomposition of urea. In some embodiments, the nitrogen-stabilizing composition inhibits the decomposition of urea by at least 10%, 20%, 30%, 40%, 50%, 60%, 70%, 80%, 90%, or at least 95%.

In some embodiments, the nitrogen-stabilizing composition provides a steady and continuous release of the nitrogen stabilizer component. The amount of nitrogen stabilizer component being released over a given time frame can be modulated by the number and/or type of imide groups present in the condensation products formed between the nitrogen stabilizer component and the organic acid anhydride component of the nitrogen-stabilizing composition. A skilled artisan would be aware that condensation products having a single imide group typically release the nitrogen stabilizer component at a faster rate than condensation products with two or more imide groups. The reason for the slower release rate of condensation products having two or more imide groups is because it takes more time to hydrolyze the two imide groups present in di-alkylated condensation products versus hydrolyzing one imide group present in mono-alkylated condensation products. In some embodiments, condensation products having two or more imide groups release the nitrogen stabilizer component about 10%, 20%, 30%, 40%, 50%, 60%, 70%, 80%, 90% or 95% slower compared to nitrogen-stabilizing compositions comprising condensation products with a single imide group.

Further, a skilled artisan would be aware that the hydrolysis of the imide group is also dependent upon the atoms that make up the imide group as well as the atoms surrounding the imide group. In the case of mixed di-alkylated condensation products, the hydrolysis of one imide group over another imide group can vary depending on the ease of hydrolysis of each individual imide group, and can be modulated accordingly to control the release of the nitrogen stabilizer component. A skilled artisan would be aware of how to modulate the release characteristics of a particular nitrogen stabilizer by optimizing the chemical structure of the mono-alkylated and/or di-alkylated (uniform and/or mixed) condensation products to achieve the desired release rate over a certain time period.

In some embodiments, a nitrogen stabilizer component is released from the nitrogen-stabilizing composition at a steady concentration, ranging from about 1 to about 100 mg/g, about 1 to about 75 mg/g, about 1 to about 50 mg/g, about 1 to about 40 mg/g, about 1 to about 30 mg/g, about 1 to about 20 mg/g, about 1 to about 10 mg/g, or from about 1 to about 5 mg/g.

In some embodiments, a nitrogen stabilizer component is released from the nitrogen-stabilizing composition over a time period of 1-4 weeks, 1-3 weeks, or 1-2 weeks. In some embodiments, a nitrogen stabilizer component is released from the nitrogen-stabilizing composition over a time period of 1-30 days, 1-20 days, 1-10 days or over a time period of at least 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 or 31 days. In some embodiments, a nitrogen stabilizer component is released from the nitrogen-stabilizing composition over a time period of about 1-6 months, 1-5 months, 1-4 months, 1-3 months, or of about 1-2 months.

In some embodiments, a nitrogen stabilizer component is released from the nitrogen-stabilizing composition at a concentration ranging from about 1 to about 20 mg/g over a time period of at least 10 days.

### IV. Agricultural Compositions

Any of the described nitrogen-stabilizing compositions can be combined with one or more other ingredients selected from the group consisting of fertilizer, agriculturally active compounds, seed, pesticides, herbicides, insecticides, fungicides, miticides and the like.

In some embodiments, the described nitrogen-stabilizing compositions may be mixed with the fertilizer products, applied as a surface coating to the fertilizer products, or otherwise thoroughly mixed with the fertilizer products. In some embodiments, in such combined fertilizer/nitrogen-stabilizing composition products, the fertilizer is in the form of particles having an average diameter of from about powder size (less than about 0.001 cm) to about 10 mm, more preferably from about 0.1 mm to about 5 mm, and still more preferably from about 0.15 mm to about 3 mm. The nitrogen-stabilizing composition can be present in such combined products at a level of about 0.001 g to about 20 g per 100 g fertilizer, about 0.01 to 7 g per 100 g fertilizer, about 0.08 g to about 5 g per 100 g fertilizer, or about 0.09 g to about 2 g per 100 g fertilizer. In the case of the combined fertilizer/nitrogen-stabilizing composition products, the combined product can be applied at a level so that the amount of nitrogen-stabilizing composition applied is about 10-150 g per acre of soil, about 30-125 g per acre, or about 40-120 g per acre of soil. The combined products can likewise be applied as liquid dispersions or as dry granulated products at the discretion of the user. When nitrogen-stabilizing compositions are used as a coating, the nitrogen-stabilizing composition can comprise between about 0.005% and about 15% by weight of the coated fertilizer product, about 0.01% and about 10% by weight of the coated fertilizer product, about 0.05% and about 2% by weight of the coated fertilizer product or about 0.5% and about 1% by weight of the coated fertilizer product.

### A. Fertilizers

In some embodiments, the agricultural product is a fertilizer. The fertilizer can be a solid fertilizer, such as, but not limited to, a granular and/or prill-like fertilizer, and the nitrogen-stabilizing composition can be applied to the fertilizer as a liquid dispersion or can be intermixed therewith. The fertilizer can also be in a semi-solid form (e.g., manure) where the nitrogen-stabilizing composition can also be applied to the fertilizer as a liquid dispersion or can be intermixed therewith. The fertilizer can also be in liquid form, and the nitrogen-stabilizing composition can be mixed with the liquid fertilizer.

In some embodiments, the fertilizer is or contains urea and/or ammonia, including anhydrous ammonia fertilizer. In the case of a liquid fertilizer, such as UAN, the nitrogen-stabilizing composition is usually mixed with the fertilizer liquid in appropriate quantities. In the liquid fertilizers containing urea, the urea is usually present at a level of from about 1 to about 12 moles/L, more preferably from about 2 to about 10 moles/L. Another alternative would be to impregnate urea or the fertilizer containing urea with the nitrogen-stabilizing composition during manufacture of such products. While the compositions should contain urea in some form, other types of fertilizers may be used in the agricultural composition.

Such additional secondary fertilizers can be selected from the group consisting of starter fertilizers, phosphate-based fertilizers, fertilizers containing nitrogen, fertilizers containing phosphorus, fertilizers containing potassium, fertilizers containing calcium, fertilizers containing magnesium, fertilizers containing boron, fertilizers containing chlorine, fertilizers containing zinc, fertilizers containing manganese, and/or fertilizers containing copper. In some embodiments, the additional fertilizer comprises plant-available nitrogen, phosphorous, potassium, sulfur, calcium, magnesium or micronutrients. In some embodiments, the fertilizer is solid, granular, a fluid suspension, a gas, or a solutionized fertilizer. In some embodiments, the fertilizer comprises a micronutrient. A micronutrient is an essential element required by a plant in small quantities. In some embodiments, the fertilizer comprises a metal ion selected from the group consisting of: Fe, Mn, Mg, Zn, Cu, Ni, Co, Mo, V and Ca. In some embodiments, the fertilizer comprises gypsum, Kieserite Group member, potassium product, potassium magnesium sulfate, elemental sulfur, or potassium magnesium sulfate. Such fertilizers may be granular, liquid, gaseous, or mixtures (e.g., suspensions of solid fertilizer particles in liquid material). In some embodiments, the additional fertilizer is an NPK fertilizer.

Generally, the amount of such secondary fertilizers would be less than that of the urea fraction. Such dual fertilizer compositions containing the nitrogen stabilizer composition disclosed herein may be used exactly in the same fashion and in the same quantities as the corresponding urea fertilizer products for applications to fields and/or crops. In the case of solids or semi-solids, the products may be applied in the same quantities by broadcast, deep or sub-surface placement, localized placement, contact, band, hill, and row placement, before, during or after planting. Liquid compositions would typically be applied by incorporating the liquid into the soil by knife-in or other conventional methods.

When the described nitrogen stabilizer composition, or formulations thereof, is applied with the application of one or more fertilizers, the nitrogen stabilizer composition can be applied prior to, subsequent to, or simultaneously with the application of fertilizer(s).

As mentioned above, the fertilizer compositions containing the nitrogen stabilizer composition as disclosed herein can be applied in any manner which will benefit the crop of interest. In some embodiments, such compositions are applied to or throughout the growth medium prior to seeding or transplanting the desired crop plant. In some embodiments, the compositions can be applied to the root zone of growing plants.

### B. Seed

In some embodiments are described agricultural seeds coated with one or more of the described nitrogen stabilizer compositions. The nitrogen stabilizer composition can be present in the seed product at a level of from about 0.001 to about 10%, about 0.004% to about 2%, about 0.01% to about 1%, or from about 0.1% to about 1% by weight (or no more than about 10%, about 9%, about 8%, about 7% about 6%, about 5%, about 4%, about 3%, about 2%, about 1%, about 0.5%, about 0.1%, about 0.01% or no more than 0.001%), based upon the total weight of the coated seed product. A seed can be, but is not limited to, wheat, barley, oat, triticale, rye, rice, maize, soybean, cotton, or oilseed rape.

### C. Other

In some embodiments are described pesticides, herbicides, insecticides, fungicides, and/or miticides in combination with one or more of the described nitrogen stabilizer compositions. As used herein, “pesticide” refers to any agent with pesticidal activity (e.g., herbicides, insecticides, fungicides) and is preferably selected from the group consisting of insecticides, herbicides, and mixtures thereof, but normally excluding materials which assertedly have a plant-fertilizing effect, for example sodium borate and zinc compounds such as zinc oxide, zinc sulfate, and zinc chloride. For an unlimited list of pesticides, see “Farm Chemicals Handbook 2000, 2004” (Meister Publishing Co, Willoughby, Ohio), which is hereby incorporated by reference in its entirety.

Exemplary herbicides include, but are not limited to, acetochlor, alachlor, aminopyralid, atrazine, benoxacor, bromoxynil, carfentrazone, chlorsulfuron, clodinafop, clopyralid, dicamba, diclofop-methyl, dimethenamid, fenoxaprop, flucarbazone, flufenacet, flumetsulam, flumiclorac, fluroxypyr, glufosinate-ammonium, glyphosate, halosulfuron-methyl, imazamethabenz, imazamox, imazapyr, imazaquin, imazethapyr, isoxaflutole, quinclorac, MCPA, MCP amine, MCP ester, mefenoxam, mesotrione, metolachlor, s-metolachlor, metribuzin, metsulfuron-methyl, nicosulfuron, paraquat, pendimethalin, picloram, primisulfuron, propoxycarbazone, prosulfuron, pyraflufen ethyl, rimsulfuron, simazine, sulfosulfuron, thifensulfuron, topramezone, tralkoxydim, triallate, triasulfuron, tribenuron, triclopyr, trifluralin, 2,4-D, 2,4-D amine, 2,4-D ester and the like.

Exemplary insecticides include, but are not limited to, 1,2-dichloropropane, 1,3-dichloropropene, abamectin, acephate, acequinocyl, acetamiprid, acethion, acetoprole, acrinathrin, acrylonitrile, alanycarb, aldicarb, aldoxycarb, aldrin, allethrin, allosamidin, allyxycarb, alpha cypermethrin, alpha ecdysone, amidithion, amidoflumet, aminocarb, amiton, amitraz, anabasine, arsenous oxide, athidathion, azadirachtin, azamethiphos, azinphos-ethyl, azinphos-methyl, azobenzene, azocyclotin, azothoate, barium hexafluorosilicate, barthrin, benclothiaz, bendiocarb, benfuracarb, benoxafos, bensultap, benzoximate, benzyl benzoate, beta cyfluthrin, beta cypermethrin, bifenazate, bifenthrin, binapacryl, bioallethrin, bioethanomethrin, biopermethrin, bistrifluron, borax, boric acid, bromfenvinfos, bromo DDT, bromocyclen, bromophos, bromophos-ethyl, bromopropylate, bufencarb, buprofezin, butacarb, butathiofos, butocarboxim, butonate, butoxycarboxim, cadusafos, calcium arsenate, calcium polysulfide, camphechlor, carbanolate, carbaryl, carbofuran, carbon disulfide, carbon tetrachloride, carbophenothion, carbosulfan, cartap, chinomethionat, chlorantraniliprole, chlorbenside, chlorbicyclen, chlordane, chlordecone, chlordimeform, chlorethoxyfos, chlorfenapyr, chlorfenethol, chlorfenson, chlorfensulphide, chlorfenvinphos, chlorfluazuron, chlormephos, chlorobenzilate, chloroform, chloromebuform, chloromethiuron, chloropicrin, chloropropylate, chlorphoxim, chlorprazophos, chlorpyrifos, chlorpyrifos-methyl, chlorthiophos, chromafenozide, cinerin I, cinerin II, cismethrin, cloethocarb, clofentezine, closantel, clothianidin, copper acetoarsenite, copper arsenate, copper naphthenate, copper oleate, coumaphos, coumithoate, crotamiton, crotoxyphos, cruentaren A & B, crufomate, cryolite, cyanofenphos, cyanophos, cyanthoate, cyclethrin, cycloprothrin, cyenopyrafen, cyflumetofen, cyfluthrin, cyhalothrin, cyhexatin, cypermethrin, cyphenothrin, cyromazine, cythioate, d-limonene, dazomet, DBCP, DCIP, DDT, decarbofuran, deltamethrin, demephion, demephion-O, demephion-S, demeton, demeton methyl, demeton-O, demeton-O-methyl, demeton-S, demeton-S-methyl, demeton-S-methyl sulphon, diafenthiuron, dialifos, diamidafos, diazinon, dicapthon, dichlofenthion, dichlofluanid, dichlorvos, dicofol, dicresyl, dicrotophos, dicyclanil, dieldrin, dienochlor, diflovidazin, diflubenzuron, dilor, dimefluthrin, dimefox, dimetan, dimethoate, dimethrin, dimethylvinphos, dimetilan, dinex, dinobuton, dinocap, dinocap-4, dinocap-6, dinocton, dinopenton, dinoprop, dinosam, dinosulfon, dinotefuran, dinoterbon, diofenolan, dioxabenzofos, dioxacarb, dioxathion, diphenyl sulfone, disulfiram, disulfoton, dithicrofos, DNOC, dofenapyn, doramectin, ecdysterone, emamectin, EMPC, empenthrin, endosulfan, endothion, endrin, EPN, epofenonane, eprinomectin, esfenvalerate, etaphos, ethiofencarb, ethion, ethiprole, ethoate-methyl, ethoprophos, ethyl DDD, ethyl formate, ethylene dibromide, ethylene dichloride, ethylene oxide, etofenprox, etoxazole, etrimfos, EXD, famphur, fenamiphos, fenazaflor, fenazaquin, fenbutatin oxide, fenchlorphos, fenethacarb, fenfluthrin, fenitrothion, fenobucarb, fenothiocarb, fenoxacrim, fenoxycarb, fenpirithrin, fenpropathrin, fenpyroximate, fenson, fensulfothion, fenthion, fenthion-ethyl, fentrifanil, fenvalerate, fipronil, flonicamid, fluacrypyrim, fluazuron, flubendiamide, flubenzimine, flucofuron, flucycloxuron, flucythrinate, fluenetil, flufenerim, flufenoxuron, flufenprox, flumethrin, fluorbenside, fluvalinate, fonofos, formetanate, formothion, formparanate, fosmethilan, fospirate, fosthiazate, fosthietan, fosthietan, furathiocarb, furethrin, furfural, gamma cyhalothrin, gamma HCH, halfenprox, halofenozide, HCH, HEOD, heptachlor, heptenophos, heterophos, hexaflumuron, hexythiazox, HHDN, hydramethylnon, hydrogen cyanide, hydroprene, hyquincarb, imicyafos, imidacloprid, imiprothrin, indoxacarb, iodomethane, IPSP, isamidofos, isazofos, isobenzan, isocarbophos, isodrin, isofenphos, isoprocarb, isoprothiolane, isothioate, isoxathion, ivermectin jasmolin I, jasmolin II, jodfenphos, juvenile hormone I, juvenile hormone II, juvenile hormone III, kelevan, kinoprene, lambda cyhalothrin, lead arsenate, lepimectin, leptophos, lindane, lirimfos, lufenuron, lythidathion, malathion, malonoben, mazidox, mecarbam, mecarphon, menazon, mephosfolan, mercurous chloride, mesulfen, mesulfenfos, metaflumizone, metam, methacrifos, methamidophos, methidathion, methiocarb, methocrotophos, methomyl, methoprene, methoxychlor, methoxyfenozide, methyl bromide, methyl isothiocyanate, methylchloroform, methylene chloride, metofluthrin, metolcarb, metoxadiazone, mevinphos, mexacarbate, milbemectin, milbemycin oxime, mipafox, mirex, MNAF, monocrotophos, morphothion, moxidectin, naftalofos, naled, naphthalene, nicotine, nifluridide, nikkomycins, nitenpyram, nithiazine, nitrilacarb, novaluron, noviflumuron, omethoate, oxamyl, oxydemeton-methyl, oxydeprofos, oxydisulfoton, paradichlorobenzene, parathion, parathion-methyl, penfluron, pentachlorophenol, permethrin, phenkapton, phenothrin, phenthoate, phorate, phosalone, phosfolan, phosmet, phosnichlor, phosphamidon, phosphine, phosphocarb, phoxim, phoxim-methyl, pirimetaphos, pirimicarb, pirimiphos-ethyl, pirimiphos-methyl, potassium arsenite, potassium thiocyanate, pp' DDT, prallethrin, precocene I, precocene II, precocene III, primidophos, proclonol, profenofos, profluthrin, promacyl, promecarb, propaphos, propargite, propetamphos, propoxur, prothidathion, prothiofos, prothoate, protrifenbute, pyraclofos, pyrafluprole, pyrazophos, pyresmethrin, pyrethrin I, pyrethrin II, pyridaben, pyridalyl, pyridaphenthion, pyrifluquinazon, pyrimidifen, pyrimitate, pyriprole, pyriproxyfen, quassia, quinalphos, quinalphos, quinalphos-methyl, quinothion, quantifies, rafoxanide, resmethrin, rotenone, ryania, sabadilla, schradan, selamectin, silafluofen, sodium arsenite, sodium fluoride, sodium hexafluorosilicate, sodium thiocyanate, sophamide, spinetoram, spinosad, spirodiclofen, spiromesifen, spirotetramat, sulcofuron, sulfiram, sulfluramid, sulfotep, sulfur, sulfuryl fluoride, sulprofos, tau fluvalinate, tazimcarb, TDE, tebufenozide, tebufenpyrad, tebupirimfos, teflubenzuron, tefluthrin, temephos, TEPP, terallethrin, terbufos, tetrachloroethane, tetrachlorvinphos, tetradifon, tetramethrin, tetranactin, tetrasul, theta cypermethrin, thiacloprid, thiamethoxam, thicrofos, thiocarboxime, thiocyclam, thiodicarb, thiofanox, thiometon, thionazin, thioquinox, thiosultap, thuringiensin, tolfenpyrad, tralomethrin, transfluthrin, transpermethrin, triarathene, triazamate, triazophos, trichlorfon, trichlormetaphos 3, trichloronat, trifenofos, triflumuron, trimethacarb, triprene, vamidothion, vamidothion, vaniliprole, vaniliprole, XMC, xylylcarb, zeta cypermethrin and zolaprofos.

Exemplary fungicides include, but are not be limited to, acibenzolar, acylamino acid fungicides, acypetacs, aldimorph, aliphatic nitrogen fungicides, allyl alcohol, amide fungicides, ampropylfos, anilazine, anilide fungicides, antibiotic fungicides, aromatic fungicides, aureofungin, azaconazole, azithiram, azoxystrobin, barium polysulfide, benalaxyl, benalaxyl-M, benodanil, benomyl, benquinox, bentaluron, benthiavalicarb, benzalkonium chloride, benzamacril, benzamide fungicides, benzamorf, benzanilide fungicides, benzimidazole fungicides, benzimidazole precursor fungicides, benzimidazolylcarbamate fungicides, benzohydroxamic acid, benzothiazole fungicides, bethoxazin, binapacryl, biphenyl, bitertanol, bithionol, bixafen, blasticidin-S, Bordeaux mixture, boric acid, boscalid, bridged diphenyl fungicides, bromuconazole, bupirimate, Burgundy mixture, buthiobate, sec-butylamine, calcium polysulfide, captafol, captan, carbamate fungicides, carbamorph, carbanilate fungicides, carbendazim, carboxin, carpropamid, carvone, Cheshunt mixture, chinomethionat, chlobenthiazone, chloraniformethan, chloranil, chlorfenazole, chlorodinitronaphthalene, chloroform, chloroneb, chloropicrin, chlorothalonil, chlorquinox, chlozolinate, ciclopirox, climbazole, clotrimazole, conazole fungicides, conazole fungicides (imidazoles), conazole fungicides (triazoles), copper(II) acetate, copper(II) carbonate, basic, copper fungicides, copper hydroxide, copper naphthenate, copper oleate, copper oxychloride, copper(II) sulfate, copper sulfate, basic, copper zinc chromate, cresol, cufraneb, cuprobam, cuprous oxide, cyazofamid, cyclafuramid, cyclic dithiocarbamate fungicides, cycloheximide, cyflufenamid, cymoxanil, cypendazole, cyproconazole, cyprodinil, dazomet, DBCP, debacarb, decafentin, dehydroacetic acid, dicarboximide fungicides, dichlofluanid, dichlone, dichlorophen, dichlorophenyl, dichlozoline, diclobutrazol, diclocymet, diclomezine, dicloran, diethofencarb, diethyl pyrocarbonate, difenoconazole, diflumetorim, dimethirimol, dimethomorph, dimoxystrobin, diniconazole, diniconazole-M, dinitrophenol fungicides, dinobuton, dinocap, dinocap-4, dinocap-6, dinocton, dinopenton, dinosulfon, dinoterbon, diphenylamine, dipyrithione, disulfiram, ditalimfos, dithianon, dithiocarbamate fungicides, DNOC, dodemorph, dodicin, dodine, donatodine, drazoxolon, edifenphos, epoxiconazole, etaconazole, etem, ethaboxam, ethirimol, ethoxyquin, ethylene oxide, ethylmercury 2,3-dihydroxypropyl mercaptide, ethylmercury acetate, ethylmercury bromide, ethylmercury chloride, ethylmercury phosphate, etridiazole, famoxadone, fenamidone, fenaminosulf, fenapanil, fenarimol, fenbuconazole, fenfuram, fenhexamid, fenitropan, fenoxanil, fenpiclonil, fenpropidin, fenpropimorph, fentin, ferbam, ferimzone, fluazinam, fluconazole, fludioxonil, flumetover, flumorph, fluopicolide, fluoroimide, fluotrimazole, fluoxastrobin, fluquinconazole, flusilazole, flusulfamide, flutolanil, flutriafol, fluxapyroxad, folpet, formaldehyde, fosetyl, fuberidazole, furalaxyl, furametpyr, furamide fungicides, furanilide fungicides, furcarbanil, furconazole, furconazole-cis, furfural, furmecyclox, furophanate, glyodin, griseofulvin, guazatine, halacrinate, hexachlorobenzene, hexachlorobutadiene, hexachlorophene, hexaconazole, hexylthiofos, hydrargaphen, hymexazol, imazalil, imibenconazole, imidazole fungicides, iminoctadine, inorganic fungicides, inorganic mercury fungicides, iodomethane, ipconazole, iprobenfos, iprodione, iprovalicarb, isopropyl alcohol, isoprothiolane, isovaledione, isopyrazam, kasugamycin, ketoconazole, kresoxim-methyl, lime sulfur (lime sulphur), mancopper, mancozeb, maneb, mebenil, mecarbinzid, mepanipyrim, mepronil, mercuric chloride (obsolete), mercuric oxide (obsolete), mercurous chloride (obsolete), metalaxyl, metalaxyl-M (a.k.a. Mefenoxam), metam, metazoxolon, metconazole, methasulfocarb, methfuroxam, methyl bromide, methyl isothiocyanate, methylmercury benzoate, methylmercury dicyandiamide, methylmercury pentachlorophenoxide, metiram, metominostrobin, metrafenone, metsulfovax, milneb, morpholine fungicides, myclobutanil, myclozolin, N-(ethylmercury)-p-toluenesulfonanilide, nabam, natamycin, nystatin, 3-nitrostyrene, nitrothal-isopropyl, nuarimol, OCH, octhilinone, ofurace, oprodione, organomercury fungicides, organophosphorus fungicides, organotin fungicides (obsolete), orthophenyl phenol, orysastrobin, oxadixyl, oxathiin fungicides, oxazole fungicides, oxine copper, oxpoconazole, oxycarboxin, pefurazoate, penconazole, pencycuron, pentachlorophenol, penthiopyrad, phenylmercuriurea, phenylmercury acetate, phenylmercury chloride, phenylmercury derivative of pyrocatechol, phenylmercury nitrate, phenylmercury salicylate, phenylsulfamide fungicides, phosdiphen, phosphite, phthalide, phthalimide fungicides, picoxystrobin, piperalin, polycarbamate, polymeric dithiocarbamate fungicides, polyoxins, polyoxorim, polysulfide fungicides, potassium azide, potassium polysulfide, potassium thiocyanate, probenazole, prochloraz, procymidone, propamocarb, propiconazole, propineb, proquinazid, prothiocarb, prothioconazole, pyracarbolid, pyraclostrobin, pyrazole fungicides, pyrazophos, pyridine fungicides, pyridinitril, pyrifenox, pyrimethanil, pyrimidine fungicides, pyroquilon, pyroxychlor, pyroxyfur, pyrrole fungicides, quinacetol, quinazamid, quinconazole, quinoline fungicides, quinomethionate, quinone fungicides, quinoxaline fungicides, quinoxyfen, quintozene, rabenzazole, salicylanilide, silthiofam, silver, simeconazole, sodium azide, sodium bicarbonate[2][3], sodium orthophenylphenoxide, sodium pentachlorophenoxide, sodium polysulfide, spiroxamine, streptomycin, strobilurin fungicides, sulfonanilide fungicides, sulfur, sulfuryl fluoride, sultropen, TCMTB, tebuconazole, tecloftalam, tecnazene, tecoram, tetraconazole, thiabendazole, thiadifluor, thiazole fungicides, thicyofen, thifluzamide, thymol, triforine, thiocarbamate fungicides, thiochlorfenphim, thiomersal, thiophanate, thiophanate-methyl, thiophene fungicides, thioquinox, thiram, tiadinil, tioxymid, tivedo, tolclofos-methyl, tolnaftate, tolylfluanid, tolylmercury acetate, triadimefon, triadimenol, triamiphos, triarimol, triazbutil, triazine fungicides, triazole fungicides, triazoxide, tributyltin oxide, trichlamide, tricyclazole, tridemorph, trifloxystrobin, triflumizole, triforine, triticonazole, unclassified fungicides, undecylenic acid, uniconazole, uniconazole-P, urea fungicides, validamycin, valinamide fungicides, vinclozolin, voriconazole, zarilamid, zinc naphthenate, zineb, ziram, and/or zoxamide.

Exemplary classes of miticides include, but are not be limited to, botanical acaricides, bridged diphenyl acaricides, carbamate acaricides, oxime carbamate acaricides, carbazate acaricides, dinitrophenol acaricides, formamidine acaricides, isoxaline acaricides, macrocyclic lactone acaricides, avermectin acaricides, milbemycin acaricides, milbemycin acaricides, mite growth regulators, organochlorine acaricides, organophosphate acaricides, organothiophosphate acaricides, phosphonate acaricides, phosphoarmidothiolate acaricies, organitin acaricides, phenylsulfonamide acaricides, pyrazolecarboxamide acaricdes, pyrethroid ether acaricide, quaternary ammonium acaricides, pyrethroid ester acaricides, pyrrole acaricides, quinoxaline acaricides, methoxyacrylate strobilurin acaricides, teronic acid acaricides, thiasolidine acaricides, thiocarbamate acaricides, thiourea acaricides, and unclassified acaricides. Examples of miticides for these classes include, but are not limited to, botanical acaricides—carvacrol, sanguinarine; bridged diphenyl acaricides - azobenzene, benzoximate, benzyl, benzoate, bromopropylate, chlorbenside, chlorfenethol, chlorfenson, chlorfensulphide, chlorobenzilate, chloropropylate, cyflumetofen, DDT, dicofol, diphenyl, sulfone, dofenapyn, fenson, fentrifanil, fluorbenside, genit, hexachlorophene, phenproxide, proclonol, tetradifon, tetrasul; carbamate acaricides—benomyl, carbanolate, carbaryl, carbofuran, methiocarb, metolcarb, promacyl, propoxur; oxime carbamate acaricides—aldicarb, butocarboxim, oxamyl, thiocarboxime, thiofanox; carbazate acaricides—bifenazate; dinitrophenol acaricides—binapacryl, dinex, dinobuton, dinocap, dinocap-4, dinocap-6, dinocton, dinopenton, dinosulfon, dinoterbon, DNOC; formamidine acaricides—amitraz, chlordimeform, chloromebuform, formetanate, formparanate, medimeform, semiamitraz; isoxazoline acaricides—afoxolaner, fluralaner, lotilaner, sarolaner; macrocyclic lactone acaricides—tetranactin; avermectin acaricides—abamectin, doramectin, eprinomectin, ivermectin, selamectin; milbemycin acaricides—milbemectin, milbemycin, oxime, moxidectin; mite growth regulators—clofentezine, cyromazine, diflovidazin, dofenapyn, fluazuron, flubenzimine, flucycloxuron, flufenoxuron, hexythiazox; organochlorine acaricides—bromociclen, camphechlor, DDT, dienochlor, endosulfan, lindane; organophosphate acaricides—chlorfenvinphos, crotoxyphos, dichlorvos, heptenophos, mevinphos, monocrotophos, naled, TEPP, tetrachlorvinphos; organothiophosphate acaricides - amidithion, amiton, azinphos-ethyl, azinphos-methyl, azothoate, benoxafos, bromophos, bromophos-ethyl, carbophenothion, chlorpyrifos, chlorthiophos, coumaphos, cyanthoate, demeton, demeton-O, demeton-S, demeton-methyl, demeton-O-methyl, demeton-S-methyl, demeton-S-methylsulphon, dialifos, diazinon, dimethoate, dioxathion, disulfoton, endothion, ethion, ethoate-methyl, formothion, malathion, mecarbam, methacrifos, omethoate, oxydeprofos, oxydisulfoton, parathion, phenkapton, phorate, phosalone, phosmet, phostin, phoxim, pirimiphos-methyl, prothidathion, prothoate, pyrimitate, quinalphos, quintiofos, sophamide, sulfotep, thiometon, triazophos, trifenofos, vamidothion; phosphonate acaricides—trichlorfon; phosphoramidothioate acaricides—isocarbophos, methamidophos, propetamphos; phosphorodiamide acaricides—dimefox, mipafox, schradan; organotin acaricides—azocyclotin, cyhexatin, fenbutatin, oxide, phostin; phenylsulfamide acaricides—dichlofluanid; phthalimide acaricides—dialifos, phosmet; pyrazole acaricides—cyenopyrafen, fenpyroximate; phenylpyrazole acaricides—acetoprole, fipronil, vaniliprole; pyrazolecarboxamide acaricides—pyflubumide, tebufenpyrad; pyrethroid ester acaricides—acrinathrin, bifenthrin, brofluthrinate, cyhalothrin, cypermethrin, alpha-cypermethrin, fenpropathrin, fenvalerate, flucythrinate, flumethrin, fluvalinate, tau-fluvalinate, permethrin; pyrethroid ether acaricides—halfenprox; pyrimidinamine acaricides—pyrimidifen; pyrrole acaricides—chlorfenapyr; quaternary ammonium acaricides—sanguinarine; quinoxaline acaricides—chinomethionat, thioquinox; methoxyacrylate strobilurin acaricides—bifujunzhi, fluacrypyrim, flufenoxystrobin, pyriminostrobin; sulfite ester acaricides—aramite, propargite; tetronic acid acaricides—spirodiclofen; tetrazine acaricides, clofentezine, diflovidazin; thiazolidine acaricides—flubenzimine, hexythiazox; thiocarbamate acaricides—fenothiocarb; thiourea acaricides—chloromethiuron, diafenthiuron; unclassified acaricides—acequinocyl, acynonapyr, amidoflumet, arsenous, oxide, clenpirin, closantel, crotamiton, cycloprate, cymiazole, disulfiram, etoxazole, fenazaflor, fenazaquin, fluenetil, mesulfen, MNAF, nifluridide, nikkomycins, pyridaben, sulfiram, sulfluramid, sulfur, thuringiensin, triarathene.

In some embodiments, a miticide can also be selected from abamectin, acephate, acequinocyl, acetamiprid, aldicarb, allethrin, aluminum phosphide, aminocarb, amitraz, azadiractin, azinphos-ethyl, azinphos-methyl, Bacillus thuringiensis, bendiocarb, beta-cyfluthrin, bifenazate, bifenthrin, bomyl, buprofezin, calcium cyanide, carbaryl, carbofuran, carbon disulfide, carbon tetrachloride, chlorfenvinphos, chlorobenzilate, chloropicrin, chlorpyrifos, clofentezine, chlorfenapyr, clothianidin, coumaphos, crotoxyphos, crotoxyphos+dichlorvos, cryolite, cyfluthrin, cyromazine, cypermethrin, deet, deltamethrin, demeton, diazinon, dichlofenthion, dichloropropene, dichlorvos, dicofol, dicrotophos, dieldrin, dienochlor, diflubenzuron, dikar (fungicide+miticide), dimethoate, dinocap, dinotefuran, dioxathion, disulfoton, emamectin benzoate, endosulfan, endrin, esfenvalerate, ethion, ethoprop, ethylene dibromide, ethylene dichloride, etoxazole, famphur, fenitrothion, fenoxycarb, fenpropathrin, fenpyroximate, fensulfothion, fenthion, fenvalerate, flonicamid, flucythrinate, fluvalinate, fonofos, formetanate hydrochloride, gamma-cyhalothrin, halofenozide, hexakis, hexythiazox, hydramethylnon, hydrated lime, indoxacarb, imidacloprid, kerosene, kinoprene, lambda-cyhalothrin, lead arsenate, lindane, malathion, mephosfolan, metaldehyde, metam-sodium, methamidophos, methidathion, methiocarb, methomyl, methoprene, methoxychlor, methoxyfenozide, methyl bromide, methyl parathion, mevinphos, mexacarbate, milky spore disease, naled, naphthalene, nicotine sulfate, novaluron, oxamyl, oxydemeton-methyl, oxythioquinox, para-dichlorobenzene, parathion, PCP, permethrin, petroleum oils, phorate, phosalone, phosfolan, phosmet, phosphamidon, phoxim, piperonyl butoxide, pirimicarb, pirimiphos-methyl, profenofos, propargite, propetamphos, propoxur, pymetrozine, pyrethroids−synthetic: see allethrin, permethrin, fenvalerate, resmethrin, pyrethrum, pyridaben, pyriproxyfen, resmethrin, rotenone, s-methoprene, soap, pesticidal, sodium fluoride, spinosad, spiromesifen, sulfotep, sulprofos, temephos, terbufos, tetrachlorvinphos, tetrachlorvinphos+dichlorvos, tetradifon, thiamethoxam, thiodicarb, toxaphene, tralomethrin, trimethacarb, and tebufenozide.

The amount of the nitrogen-stabilizing composition in agricultural compositions containing additional active agents (e.g., pesticides, herbicides, insecticides, fungicides, and/or miticides) can vary. In some embodiments, the amount of nitrogen-stabilizing composition is present at a level of from about 0.05% to about 10% by weight (preferably from about 0.1% to about 8% by weight, more preferably from about 0.1% to about 4% by weight, and most preferably from about 0.2% to about 2% by weight) based upon the total weight of the agricultural composition containing additional active agents taken as 100% by weight.

### V. Methods

In some embodiments, the nitrogen-stabilizing compositions are used directly. In other embodiments, the nitrogen-stabilizing compositions are formulated in ways to make their use convenient in the context of productive agriculture. The nitrogen-stabilizing compositions used in these methods include the nitrogen stabilizer component and organic acid anhydride component as described above. The nitrogen-stabilizing compositions can be used in methods such as:

A. Methods of Improving Plant Growth and/or Fertilizing Soil

B. Methods of Inhibiting Nitrification, Urease Decomposition or Ammonia Release or Evolution

C. Methods of Reducing Volatilization or Degradation of Nitrogen Stabilizers

D. Methods of Improving Soil Conditions

E. Methods of Preparing Nitrogen-Stabilizing Compositions

A. Methods for improving plant growth comprise contacting a nitrogen-stabilizing composition or formulation containing a nitrogen stabilizer component as disclosed herein with soil. In some embodiments, the nitrogen-stabilizing composition or formulation is applied to the soil prior to emergence of a planted crop. In some embodiments, the nitrogen-stabilizing composition or formulation is applied to the soil adjacent to the plant and/or at the base of the plant and/or in the root zone of the plant.

Methods for improving plant growth can also be achieved by applying a nitrogen-stabilizing composition or formulation containing a nitrogen stabilizer component, as disclosed herein, as a seed coating to a seed in the form of a liquid dispersion, which upon drying forms a dry residue. In these embodiments, seed coating provides the nitrogen-stabilizing composition in close proximity to the seed when planted so that the nitrogen-stabilizing composition can exert its beneficial effects in the environment where it is most needed. That is, the nitrogen-stabilizing composition provides an environment conducive to enhanced plant growth in the area where the effects can be localized around the desired plant. In the case of seeds, the coating containing the nitrogen-stabilizing composition provides an enhanced opportunity for seed germination, subsequent plant growth, and an increase in plant nutrient availability.

B. Methods for inhibiting/reducing nitrification, urease decomposition, or ammonia release or evolution in an affected area comprise applying a nitrogen-stabilizing composition or formulation containing a nitrogen stabilizer component as disclosed herein to the affected area. The affected area may be soil adjacent to a plant, a field, a pasture, a livestock or poultry confinement facility, pet litter, a manure collection zone, an upright wall forming an enclosure, or a roof substantially covering the area, and in such cases the nitrogen-stabilizing composition may be applied directly to the manure in the collection zone. Methods disclosed herein are also directed to inhibiting the conversion of urea into ammonia and/or the conversion of ammonia into nitrate comprising applying a nitrogen-stabilizing composition or formulation containing a nitrogen stabilizer component as disclosed herein to the affected area. The nitrogen-stabilizing composition is preferably applied at a level from about 0.005 to about 3 gallons per ton of manure, in the form of an aqueous dispersion having a pH from about 1 to about 5.

C. Methods of reducing volatilization and/or degradation of nitrogen stabilizer(s) comprising the formation of condensation product(s) between a nitrogen stabilizer component and an organic acid anhydride component as disclosed herein. The formed condensation products are less volatile and/or less prone to degradation compared to a nitrogen stabilizer component that is not condensed with a cyclic organic acid anhydride component as disclosed herein. In some embodiments, the formed condensation products reduce volatility by about 1% to about 50%, about 5% to about 35%, or about 10% to about 30% compared to a nitrogen stabilizer that is not condensed with a cyclic organic acid anhydride component. In some embodiments, the formed condensation products exhibit less degradation by at least 5%, 10%, 15%, 20%, 25%, 30%, 35%, 40%, 45%, 50%, 55%, 60%, 65%, 70%, or at least 75% compared to a nitrogen stabilizer that is not condensed with an organic acid anhydride component.

D. Methods for improving soil conditions selected from the group consisting of nitrification processes, urease activities, and combinations thereof, comprising the step of applying to soil an effective amount of a described nitrogen-stabilizing composition or formulation thereof. In some embodiments, the nitrogen-stabilizing composition is mixed with a solid, liquid, or gaseous fertilizer, and especially solid fertilizers; in the latter case, the nitrogen-stabilizing composition is applied to the surface of the fertilizer as an aqueous dispersion followed by drying, so that the nitrogen-stabilizing composition is present on the solid fertilizer as a dried residue. The nitrogen-stabilizing composition is generally applied at a level of from about 0.01% to about 10% by weight, based upon the total weight of the nitrogen-stabilizing composition/fertilizer product taken as 100% by weight. Where the fertilizer is an aqueous liquid fertilizer, the nitrogen-stabilizing composition is added thereto with mixing. The nitrogen-stabilizing composition is preferably in aqueous dispersion and has a pH of up to about 3.

E. Methods of preparing nitrogen-stabilizing compositions as disclosed herein comprise contacting a nitrogen stabilizer component with an acid anhydride component thereby forming condensation product(s). The contacting step can be carried out neat or can be carried out in the presence of a solvent. In some embodiments, the contacting step further comprises a non-polar solvent such as, but not limited to, acetonitrile. In some embodiments, the contacting step is carried out at ambient temperature. In some embodiments, the contacting step is carried out at elevated temperatures ranging from about 25° C. to about 150° C., from about 30° C. to about 120° C., from about 40° C. to about 100° C., from about 50° C. to about 90° C., or from about 60° C. to about 80° C. The amount of nitrogen stabilizer component and acid anhydride component can vary. In some embodiments, the nitrogen stabilizer component and the acid anhydride component are present in a molar ratio ranging from about 1:2 to about 2:1.

In some embodiments, the methods A, B, and D above comprise contacting a desired area with a nitrogen-stabilizing composition at a rate of about 100 g to about 120 g per acre of the nitrogen-stabilizing composition. The nitrogen-stabilizing composition can, in some embodiments, be in solution at an amount of about 0.5 lbs. to about 4 lbs. per U.S. gallon, or from about 1 lb. to about 3 lbs. per U.S. gallon, or about 2 lbs. per U.S. gallon. In some embodiments, the method includes contacting the desired area at a rate of about 0.5 to about 4 qt./acre, or about 1 to about 2 qt./acre.

1. A nitrogen-stabilizing composition comprising:
a nitrogen stabilizer component, wherein the nitrogen stabilizer component is a urease inhibitor and/or nitrification inhibitor; and
an organic acid anhydride component, wherein the organic acid anhydride component is a cyclic organic acid anhydride monomer or an organic acid anhydride polymer.

2. The nitrogen-stabilizing composition of claim 1, wherein the nitrogen stabilizer component is N-(n-butyl) thiophosphoric triamide (NBPT) and/or dicyandiamide (DCD).

3. (canceled)

4. The nitrogen-stabilizing composition of claim 1, wherein the cyclic organic acid anhydride monomer is a saturated or unsaturated five-membered cyclic organic acid anhydride monomer selected from maleic anhydride, phthalic anhydride, trimellitic anhydride, succinic anhydride, tetrahydrophthalic anhydride, hexahydrophthalic anhydride, itaconic anhydride, and a combination thereof.

5. (canceled)

6. (canceled)

7. The nitrogen-stabilizing composition of claim 1, wherein the organic acid anhydride polymer is a copolymer containing at least two different repeat units, including one of type B repeat unit and one of type C repeat unit; and/or wherein the type B repeat unit is derived from substituted or unsubstituted monomers of maleic anhydride, itaconic anhydride, or a combination thereof.

8. (canceled)

9. (canceled)

10. (canceled)

11. The nitrogen-stabilizing composition of claim 7, wherein at least about 50 mole % of the repeat units of the organic acid anhydride polymer are type B repeat units.

12. The nitrogen-stabilizing composition of any claim 7, wherein the organic acid anhydride polymer contains a type C repeat unit that is derived from substituted or substituted alkene(s) selected from ethylene, propylene, butylene, isobutylene, styrene, methyl vinyl ether and a combination thereof.

13. (canceled)

14. The nitrogen-stabilizing composition of claim 1, wherein the organic acid anhydride polymer has a structure according to formula: 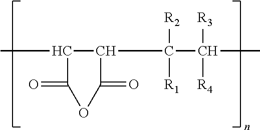
wherein R₁ R₂, R₃ and R₄ are independently selected from —H, —COOH, —COOR, —OCOH, —OCOR, —OR, —CN, —SO₂R, —SO₃R, —COR, —CONH₂, —CONHR, —CONR₂, —CHO, NO₂, halogen -alkyl, -cycloalkyl, -aryl, -alkaryl, or aralkyl, wherein R is a substituted or unsubstituted C₁-C₈ alkyl group, a substituted or unsubstituted C₂-C₈ alkenyl group, a substituted or unsubstituted aryl group, a substituted or unsubstituted heteroaryl group; and
n is an integer greater than 2.

15. (canceled)

16. The nitrogen-stabilizing composition of claim 1, wherein the nitrogen stabilizer component and the organic acid anhydride component react to form condensation product(s).

17. (canceled)

18. The nitrogen-stabilizing composition of claim 16, wherein the condensation products are mono-alkylated condensation product(s) having a general structure according to formula: 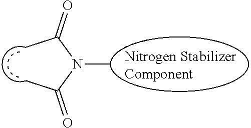
wherein the cyclic imide group in the formula is formed when a nitrogen-containing moiety of the nitrogen stabilizer component reacts with the cyclic organic acid anhydride component, and wherein [symbol] indicates any bonds in the above cyclic imide group that can be saturated or unsaturated.

19. The nitrogen-stabilizing composition of claim 16, wherein the nitrogen stabilizer component is NBPT, DCD or a combination thereof, and/or the organic acid anhydride component is a maleic anhydride monomer.

20. (canceled)

21. The nitrogen-stabilizing composition of claim 18, wherein the mono-alkylated condensation product(s) are selected from: 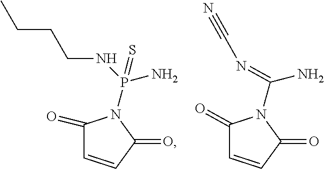
and a combination thereof.

22. (canceled)

23. The nitrogen-stabilizing composition of claim 16, wherein the condensation products are di-alkylated condensation product(s) having a general structure according to formula: 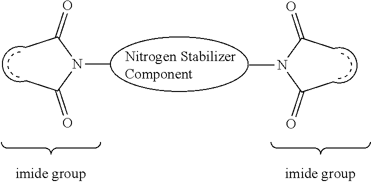
wherein the two cyclic imide groups in the formula are formed when two nitrogen-containing moieties of the nitrogen stabilizer component react with two cyclic organic acid anhydride components, and wherein [symbol] indicates any bonds in the above cyclic imide groups that can be saturated or unsaturated.

24. The nitrogen-stabilizing composition of claim 16, wherein the nitrogen stabilizer component is NBPT, DCD or a combination thereof and/or the organic acid anhydride component is a maleic anhydride monomer.

25. (canceled)

26. The nitrogen-stabilizing composition of claim 16, wherein the di-alkylated condensation product(s) are selected from:

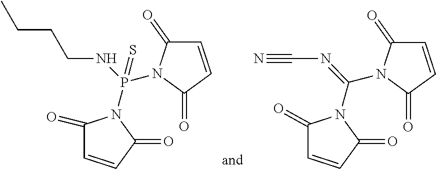 [SMILES: CCCCNP(=S)(N1C(=O)C=CC1=O)N1C(=O)C=CC1=O ; N#CN=C(N1C(=O)C=CC1=O)N1C(=O)C=CC1=O]

27. The nitrogen-stabilizing composition of claim 1, wherein the nitrogen stabilizer component is present in the nitrogen-stabilizing composition in an amount ranging from about 1% to about 40% by weight, based on the total weight of the nitrogen-stabilizing composition; and/or the organic acid anhydride component is present in the nitrogen-stabilizing composition in an amount ranging from about 1% to about 20% by weight, based on the total weight of the nitrogen-stabilizing composition.

28. (canceled)

29. (canceled)

30. The nitrogen-stabilizing composition of claim 1 further comprising a second nitrification inhibitor and/or urease inhibitor, wherein the second nitrification and/or urease inhibitor are present in an amount of about 10-70% by weight, based on the total weight of the nitrogen-stabilizing composition.

31. (canceled)

32. The nitrogen-stabilizing composition of claim 30, wherein the second nitrification inhibitor is nitrapyrin.

33. (canceled)

34. The nitrogen-stabilizing composition of claim 1 being at least 50% less volatile compared to compositions wherein the nitrogen stabilizer component is not condensed with an organic acid anhydride component and/or at least 50% more thermally stable compared to compositions that contain a nitrogen stabilizer component that is not condensed with an organic acid anhydride component.

35. (canceled)

36. (canceled)

37. The nitrogen-stabilizing composition of claim 1 being in the form of an aqueous dispersion.

38. A formulation comprising a nitrogen-stabilizing composition of claim 1 and at least one additional ingredient selected from solvents, colorants, stabilizers, film former, and mixtures thereof.

39. (canceled)

40. (canceled)

41. (canceled)

42. (canceled)

43. (canceled)

44. (canceled)

45. (canceled)

46. (canceled)

47. (canceled)

48. (canceled)

49. (canceled)
